(19) United States
(12) Patent Application Publication
(10) Pub. No.: US 2023/0266074 A1
(43) Pub. Date: Aug. 24, 2023

(54) DEVICE FOR MASS AND/OR HEAT TRANSFER AND PROCESS FOR CAPTURING A MOLECULE IN A PROCESS FLUID USING THE DEVICE

(71) Applicant: Molecule Works Inc., Richland, WA (US)

(72) Inventor: Wei LIU, Richland, WA (US)

(21) Appl. No.: 18/110,793

(22) Filed: Feb. 16, 2023

Related U.S. Application Data
(60) Provisional application No. 63/312,038, filed on Feb. 20, 2022.

(51) Int. Cl. F28D 21/00; B01D 53/04; B01D 53/88; B01D 53/26; B01D 53/047; B01J 19/24; B01J 19/32; B01J 19/00

(52) U.S. Cl. CPC F28D 21/0015; B01D 53/0438; B01D 53/885; B01D 53/261; B01D 53/047; B01D 53/0462; B01J 19/249; B01J 19/32; B01J 19/0013; F28D 2021/0022; F28D 2020/0017

(57) ABSTRACT

A device for mass and/or heat transfer includes a mass and/or heat transfer (MHX) plate having a thickness in a range from 0.5 mm to 5 mm and including a supporting matrix that is thermally conductive, and a functional material in the supporting matrix, wherein a volume fraction of the functional material in the MHX plate is in a range from 0.2 to 0.8, and a heat exchange tube configured to transport a thermal fluid and disposed on the MHX plate so that heat is transferred between the thermal fluid and the MHX plate, wherein a surface of the MHX plate includes a process flow channel of hydraulic diameter in a range from 0.3 mm to 3 mm and a process fluid in the process flow channel exchanges mass and/or heat with the MHX plate.

### RELATED APPLICATIONS

This application claims the benefit of priority from U.S. Provisional Application No. 63/312,038, entitled “DEVICE FOR HEAT AND MASS TRANSFER AND PROCESS FOR CAPTURING A MOLECULE IN A PROCESS FLUID USING THE DEVICE,” filed on Feb. 20, 2022, the entire contents of which are incorporated herein by reference for all purposes.

### FIELD OF INVENTION

The present disclosure is directed to device for mass and/or heat transfer and, more particularly, a device that may be used to capture or convert a molecule in a process fluid.

### BACKGROUND

In chemical processing industries, mass and heat transfer as well as hydrodynamics may become a limiting factor to productivity and energy efficiency. Adsorption may be used for the removal of certain molecules from a process stream by use of an adsorbent or sorbent material. The saturated adsorbent is often regenerated by heating the saturated adsorbent material up to a higher temperature than adsorption.

To process a fluid at a large volume flow rate, adsorption from the bulk fluid to the saturated adsorbent should be rapid enough to reduce the adsorbent/fluid contactor size, and the pressure drop through the contactor should be small enough to reduce power consumption. To have high productivity of the adsorbent and contactor, the adsorbent should be rapidly heated and cooled down to shorten the regeneration turn-around time. Application examples of these techniques may include 1) capturing CO₂ from air, flue gas, or process streams; 2) removing moisture from air or process streams, and 3) removing organic compounds or hydrocarbons from air, exhaust, or process streams. In these applications, selective adsorbents may be heated up to release the adsorbed species and cooled down for reuse, which is called the regeneration process. The heating and cooling time, i.e., regeneration time, may have a direct impact on utilization of the adsorbent material and equipment. For example, current desiccant adsorbent beds for industrial drying processes often take days to complete regeneration. Such slow regeneration turn-around may be too costly to meet some new application needs, such as, CO₂ capture, recovery of alcohols from dilute process streams, air dehumidification in buildings, hydrogen gas purification, etc.

Low pressure drops may be addressed by making the adsorbent bed in structured forms, such as monoliths, plates, tubes, fibers, etc. However, rapid heating and cooling of large sizes of the adsorbent beds or adsorbent volumes may be challenging. Active adsorbent or catalyst materials are typically made of highly porous metal oxide or type of materials with low thermal conductivity. For example, alumina, silica, and Al—Si—O compounds of high Brunauer—Emmett—Teller (BET) surface area may have low thermal conductivity in the range of 0.1 to 1.0 W/(m·K), about two to three orders of magnitude less than metals such as copper and aluminum. A relatively new class of adsorbent material—metal organic framework (MOF)—may also have a low thermal conductivity. It may be an industrial practice to heat up a large adsorbent bed with hot gas flow. Such an approach may have additional problems. One problem may be that specific heating capacity of gas is about three orders of magnitude less than liquid-phase thermal fluid and a large volume of gas flow is needed. Another problem is the source of hot gas streams. Steam is often used but it is expensive.

### SUMMARY

Various embodiments disclosed herein may include a device for mass and/or heat transfer that may include a mass and/or heat transfer (MHX) plate. The MHX plate may have a thickness in a range from 0.5 mm to 5 mm. The MHX plate may include a supporting matrix that is thermally conductive, wherein a functional material may be immobilized in the supporting matrix. A volume fraction of the functional material in the MHX plate may be in a range from 0.2 to 0.8. The device for mass and/or heat transfer may also include a heat exchange tube that may be configured to transport a thermal fluid. The heat exchange tube may be disposed on the MHX plate so that heat may be transferred between the thermal fluid and the MHX plate, wherein a surface of the MHX plate may include a process flow channel having a hydraulic diameter that may be in a range from 0.3 mm to 3 mm. A process fluid contained in the process flow channel may exchange mass and/or heat with the MHX plate. In most chemical processes, single-phase fluid such as gas and liquid, and two-phase fluid (gas-liquid, gas-solid, liquid-solid) may be used to transport heat into or out of the heat exchange tubes. In some special cases, electricity may be used as a “thermal fluid” to heat. In such cases, the heat exchange tube and the supporting matrix may be viewed as the electricity conduit and electrical conducting matrix, respectively.

Various embodiments disclosed herein may also include a device for adsorption and desorption of a molecule in a process fluid. Various embodiment devices may include a mass and/or heat transfer plates including a MHX plate. The MHX plate may have a thermal conductivity greater than 20 W/(m·K) and a thickness in a range from 0.5 mm to 5.0 mm. The MHX plate may include a supporting matrix that includes a plurality of voids. Each of the plurality of voids may have a hydraulic diameter in a range from 0.5 mm to 6.0 mm. An adsorbent material may be immobilized inside the plurality of voids at a volume fraction in a range from 0.2 to 0.80, wherein the MHX plate includes a surface for diffusional mass transfer between the process fluid and the functional adsorbent material. Various embodiment devices may further include a plurality of: a heat exchange tube disposed on the plurality of mass and heat MHX plates configured to transfer heat between a thermal fluid and the plurality of mass and heat MHX plates by thermal conduction; and a process flow channel configured to flow the process fluid to the MHX plate, wherein the process flow channel may be disposed proximate to the MHX plate and a containment wall, wherein the process flow channel has a hydraulic diameter in a range from 0.3 mm to 3.0 mm.

Various embodiments disclosed herein may also include a device for catalytic reaction of a molecule in a process fluid. The various embodiment devices may include a mass and/or heat transfer plate that may transfer heat by thermal conduction. The various embodiment devices may further include a MHX plate having a thermal conductivity greater than 20 W/(m·K) and a thickness in a range from 0.5 mm to 5.0 mm. The MHX plate may include a supporting matrix that includes a plurality of voids having a hydraulic diameter in a range from 0.5 to 6.0 mm, and a catalytic material immobilized inside the plurality of voids at a volume fraction in a range from 0.2 to 0.80. The MHX plate may include: a surface for diffusional mass transfer between the process fluid and the catalytic material; a heat exchange tube disposed on the MHX plate and configured to transfer heat between a thermal fluid in the heat exchange tube and the MHX plate by thermal conduction, and a process channel for flowing the process fluid between the MHX plate and heat exchange tube, wherein the process channel may be disposed proximate to the MHX plate and a containment wall, the process channel having a hydraulic diameter in a range from 0.3 mm to 3.0 mm.

Various embodiments disclosed herein may also include a device for thermal energy storage and heat exchange. The various embodiment devices may include a mass and/or heat transfer (MHX) plate having a thermal conductivity greater than 20 W/(m·K) and a thickness in a range from 0.5 mm to 5.0 mm. The MHX plate may include a supporting matrix that includes a plurality of voids having a hydraulic diameter in a range from 0.5 to 6.0 mm, and a thermal energy storage material immobilized inside the plurality of voids at a volume fraction in a range from 0.2 to 0.80. The MHX plate includes a surface for heat transfer between a process fluid and the thermal storage material, a heat exchange tube disposed on the MHX plate and configured to transfer heat between a thermal fluid and the MHX plate by thermal conduction, and a process channel for flowing the process fluid to the MHX plate and disposed proximate to the MHX plate and a containment wall, the process channel having a hydraulic diameter in a range from 0.3 mm to 3.0 mm.

Various embodiments disclosed herein may also include a method for capturing a molecule from a process fluid. The various embodiment methods may include the steps of providing an integrated mass and/or heat transfer (IMHX) device in a vessel, the IMHX device including a plurality of mass and heat transfer (MHX) plates comprising a supporting matrix and an adsorbent material immobilized in the supporting matrix, a plurality of heat exchange tubes disposed on the plurality of MHX plates, a heat exchange tube disposed on the MHX plate, and a channel for flowing the process fluid between the plurality of MHX plates. The embodiment methods may also include the steps of: passing the process fluid through the channel to the MHX plate at a pressure drop of less than 1001 kPa, so that the molecule in the process fluid may be adsorbed by the adsorbent material; introducing a cold thermal fluid into the plurality of heat exchange tubes of the IMHX device for removal of heat of adsorption; stopping the passing of the process fluid in response to a concentration of the molecule in the process fluid exiting the IMHX device is above or below a threshold value; introducing a hot thermal fluid into the plurality of heat exchange tubes of the IMHX device to heat the adsorbent to a temperature for desorption of the adsorbed molecule from the adsorbent material; and introducing cold thermal fluid into the heat exchange tubes of the IMHX device to cool the adsorbent material to a temperature close to a process temperature.

Various embodiment methods disclosed herein may also include steps for capturing CO₂ from air including providing an integrated mass and/or heat transfer (IMHX) device in a vessel, the IMHX device including a mass and/or heat transfer (MHX) plate. The MHX plate may include a supporting matrix and an adsorbent material immobilized in the supporting matrix, a heat exchange tube disposed on the MHX plate, and a channel configured to flow air to the MHX plate. The various embodiment methods may also include: passing air through the channel at a pressure drop less than 1 kPa so that CO₂ in the air is adsorbed on the adsorbent material; stopping a flow of the air in response to a CO₂ concentration of the air exiting the IMHX device being below a threshold values; switching a mode of the IMHX device to a regeneration mode; introducing a hot thermal fluid into the heat exchange tube of the IMHX device to heat the adsorbent to a temperature for desorption of the adsorbed CO₂ from the adsorbent material; and introducing cold thermal fluid into the heat exchange tube of the IMHX device to cool the adsorbent material to an ambient air temperature.

### BRIEF DESCRIPTION OF THE FIGURES

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a cross-sectional view of mass and/or heat transfer (MHX) plate stacking, according to one or more embodiments.

FIG. 1B is a schematic diagram of rounded heat exchange tubes on the MHX plate, according to one or more embodiments.

FIG. 1C is a schematic diagram of rectangular heat exchange tubes on the MHX plate, according to one or more embodiments.

FIG. 2A is a cross-sectional view of MHX plate stacking, according to one or more embodiments.

FIG. 2B is a schematic diagram of rectangular heat exchange tubes, according to one or more embodiments.

FIG. 2C is a plan view (e.g., top-down view) of a one-layer IMHX structure with manifold connection of individual heat exchange tubes, according to one or more embodiments.

FIG. 3 illustrates components and thickness of an MHX plate, according to one or more embodiments.

FIG. 4A-4E illustrate the encapsulation medium with a few examples (top-down view), according to one or more embodiments.

FIG. 5A illustrates a supporting matrix including perforated rectangular voids, according to one or more embodiments.

FIG. 5B illustrates a supporting matrix including perforated rounded voids, according to one or more embodiments.

FIG. 5C illustrates a supporting matrix including perforated triangular voids, according to one or more embodiments.

FIG. 5D illustrates a supporting matrix including perforated hexagonal voids, according to one or more embodiments.

FIG. 6A is a plan view of the rectangular slot filled with functional materials, according to one or more embodiments.

FIG. 6B is a cross-sectional view (A-A′) of the rectangular slot filled with functional materials, according to one or more embodiments.

FIG. 6C is a plan view of the perforated voids filled with functional materials, according to one or more embodiments.

FIG. 6D is a cross-sectional view (B-B′) of the perforated voids filled with functional materials, according to one or more embodiments.

FIG. 7A is a plan view of the rectangular slot filled with functional materials and covered by the encapsulation medium, according to one or more embodiments.

FIG. 7B is a cross-sectional view (C-C′) of the rectangular slot filled with functional materials and covered by the encapsulation medium, according to one or more embodiments.

FIG. 7C is a plan view of the perforated voids filled with functional materials and covered by the encapsulation medium, according to one or more embodiments.

FIG. 7D is a cross-sectional view (D-D′) of the perforated voids filled with functional materials and covered by the encapsulation medium, according to one or more embodiments.

FIG. 8A is a plan view (top-down) of the mini-cavities filled with functional materials in a symmetric top and bottom configuration, according to one or more embodiments.

FIG. 8B is a cross-sectional view (E-E′) of the mini-cavities filled with functional materials in symmetric top and bottom configuration, according to one or more embodiments.

FIG. 8C is a plan view of the mini-cavities filled with functional materials in alternating top and bottom configuration, according to one or more embodiments.

FIG. 8D is a cross-sectional view (F-F′) of the mini-cavities filled with functional materials in alternating top and bottom configuration, according to one or more embodiments.

FIG. 9A is a plan view of the mini-cavities filled with functional materials and covered by the encapsulation medium in a symmetric top and bottom configuration, according to one or more embodiments.

FIG. 9B is a cross-sectional view (G-G′) of the mini-cavities filled with functional materials and covered by the encapsulation medium in a symmetric top and bottom configuration, according to one or more embodiments.

FIG. 9C is a plan view of the mini-cavities filled with functional materials and covered by the encapsulation medium in an alternating top and bottom configuration, according to one or more embodiments.

FIG. 9D is a cross-sectional view (H-H′) of the mini-cavities filled with functional materials and covered by the encapsulation medium in an alternating top and bottom configuration, according to one or more embodiments.

FIG. 10A is a plan view of the top and bottom layer of functional materials sandwiched by the encapsulation medium, according to one or more embodiments.

FIG. 10B is a cross-sectional view (I-I′) of the top and bottom layer of functional materials sandwiched by the encapsulation medium, according to one or more embodiments.

FIG. 10C is a plan view of the functional materials immobilized by the encapsulation medium into a sheet form attached to a top and bottom of the supporting plate, according to one or more embodiments.

FIG. 10D is a cross-sectional view (J-J′) of the functional materials immobilized by the encapsulation medium into a sheet form attached to a top and bottom of the supporting plate, according to one or more embodiments.

FIG. 11A illustrates a simplified physical model of the IMHX structure with rectangular heat exchange tubes, according to one or more embodiments.

FIG. 11B is a graph illustrating temperature variation along a distance of the MHX plate, according to one or more embodiments.

FIG. 12A illustrates a simplified physical model of the IMHX structure with rounded heat exchange tubes, according to one or more embodiments.

FIG. 12B is a graph illustrating temperature variation along a distance of the MHX plate, according to one or more embodiments.

FIG. 13A illustrates a simplified physical model of the MHX plate, according to one or more embodiments.

FIG. 13B is a graph plotting an effectiveness factor of the MHX plate vs. Thiele modulus, according to one or more embodiments.

FIG. 14A is a view of the IMHX module along a process flow direction, according to one or more embodiments.

FIG. 14B is a view of the IMHX module in a direction perpendicular to process flow, according to one or more embodiments.

FIG. 15A is a view of the IMHX module for adsorption at high pressure and low temperature, according to one or more embodiments.

FIG. 15B is a view of the IMHX module for regeneration at low pressure and high temperature, according to one or more embodiments.

FIG. 16A is a view of the IMHX module for performing adsorption at process pressure and temperature, according to one or more embodiments.

FIG. 16B is a view of the IMHX module for performing regeneration at lower pressure and higher temperature, according to one or more embodiments.

FIG. 17A is a view of the IMHX module for performing adsorption at process pressure and temperature, according to one or more embodiments.

FIG. 17B is a view of the IMHX module for performing regeneration at lower pressure and higher temperature, according to one or more embodiments.

FIG. 18A is a view of the IMHX module for performing air heating at a designated heating temperature, according to one or more embodiments.

FIG. 18B is a view of the IMHX module for performing air cooling at a designated cooling temperature, according to one or more embodiments.

FIG. 19 illustrate an application of the IMHX module to hydrogenation of CO₂ into methanol, according to one or more embodiments.

FIG. 20 shows an example of an MHX supporting plate (e.g., supporting matrix), according to one or more embodiments.

FIG. 21A is cross-sectional view of the IMHX module including a stack of a group of identical MHX plates with a few auxiliary parts, according to one or more embodiments.

FIG. 21B is a top-down view of filling the gap between the heat exchange tube and the MHX plate with a heat transfer filler, according to one or more embodiments.

FIG. 22 is a schematic view of an IMHX module unit, according to one or more embodiments.

FIG. 23A is an air entrance view of the modular cart including the group of IMHX module units, according to one or more embodiments.

FIG. 23B is a vertical cross-sectional view of the modular cart including air flow paths, according to one or more embodiments.

FIG. 24A is an air entrance view of the modular cart including the group of IMHX module units, according to one or more embodiments.

FIG. 24B is a vertical cross-sectional view of the modular cart including air flow paths, according to one or more embodiments.

FIG. 25 is a schematic diagram of a molecule (e.g., CO₂) capturing plant with rotating modular carts between an indoor regeneration chamber and outdoor capture, according to one or more embodiments.

FIG. 26 is a schematic diagram of a molecule (e.g., CO₂) capturing plant with rotating modular carts between an indoor regeneration chamber and atmospheric enclosure, according to one or more embodiments.

FIG. 27 is a process flow diagram of a direct air capturing (DAC) plant including the IMHX module, according to one or more embodiments.

FIG. 28 is a flowchart illustrating a method for capturing a molecule from a process fluid, according to one or more embodiments.

FIG. 29 is a flowchart illustrating a method for capturing CO₂ from air, according to one or more embodiments.

### DETAILED DESCRIPTION

The embodiments will now be described more fully hereinafter with reference to the accompanying figures, in which exemplary embodiments are shown. The foregoing may, however, be embodied in many different forms and should not be construed as limited to the exemplary embodiments set forth herein.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

Orientation or direction described or shown in the drawings is to show working principles and structural features, and may not represent orientation or direction in an actual operating device. For example, top and bottom sides of the plate shown in a drawing may also be referred to as the left or right sides of the plate.

The term “functional material” may be understood to include any material that may physically or chemically interact with molecules, adsorbents, sorbents, catalysts, or their mixture and any materials that may produce heat or update heat in response to being exposed to a process fluid.

A heat exchanger may be immersed in a shallow particle-packed bed such that the adsorbent may be quickly heated and cooled by a thermal fluid flowing across the heat exchanger. In the particle-packed bed, particle attribution may occur under dynamic gas flow, and thermal conductivity of the packed adsorbent particle may be low. A coating of adsorbents on metallic heat exchangers or fins may enable realization of rapid heat transfer between the adsorbent and thermal fluid. Such a design may be effective in embodiments in which a thin coating (e.g., having a thickness less than about 50 μm) is used. However, in embodiments in which a thick coating is used, problems may occur such as delamination, crack or deactivation. For these reasons, stable thick coatings (e.g., in the order of mm) are not widely implemented. Although a high heat transfer rate may be realized with a thin coating on the heat exchanger, the thin coating may provide low adsorption capacity per unit of reactor (or exchanger) and a large fraction of non-adsorbent thermal mass, which may ultimately lead to high capital cost and high energy consumption.

Various embodiment devices disclosed herein provide low pressure drops, a high loading fraction of active adsorbent materials, and a high heat transfer rate between the adsorbent and thermal fluid. The various embodiments disclosed herein may help to enable an adsorption process with high productivity, low capital cost, and low energy consumption.

It may be desirable to provide exothermic or endothermic catalytic reactions over a solid catalyst that provide rapid mass and/or heat transfer. Heat may be continuously applied to the endothermic reaction to maintain a desired reaction temperature. Otherwise, the reaction may be quenched. One example of such reaction quench may be the dehydration of ethanol to produce ethylene or olefins. In contrast, in an exothermic reaction, heat may be continuously removed to avoid temperature run-away. Examples of exothermic reactions with current and future industrial significance include 1) hydrogenation of CO into methanol or hydrocarbons, 2) hydrogenation of CO₂ to methanol or hydrocarbons, 3) reaction of CO and hydrogen to hydrocarbons (Fischer—Tropsch reaction), 4) selective hydrogenation of double or triple bonds, 5) reforming of methanol into C2 or C2+ hydrocarbons, and 6) selective oxidation of alcohols or hydrocarbons.

Heat exchanger tubular reactors are widely used in today's industrial processes. However, reaction productivity in the tubular reactor may be considered low. Micro-channel or mini-channel reactors have been developed to dramatically enhance heat transfer between the catalyst and heat exchange fluid. However, in such micro-channel reactors, catalyst loading and pressure drop limitations may exist. Similar to adsorbent coatings, catalyst coatings on the heat exchanger may be provided in a thin layer. Thick coatings may result in cracks, delamination, loss of molecular diffusivity, or loss of catalytic activity. In instances in which the microchannel is filled with catalyst particles, the pressure drop may become too large. One or more embodiments of the present disclosure may also address the pressure drop, heat and mass transfer problems for endothermic catalytic reactions and/or exothermic catalytic reactions.

It has been a long-term challenge in the chemical engineering field to design and build a fluid contactor of high productivity with characteristics of rapid mass transfer and heat transfer as well as small pressure drops. The challenge may be magnified for processing of large volume flow rates by adsorption and/or catalytic reaction. One application example is capturing CO₂ from air or flue gas. Because of low CO₂ concentrations and atmospheric pressure of these process streams, fast adsorption and low-pressure drops may promote processing large volume flow rates. Because the CO₂-selective adsorbent or sorbent may be regenerated by heating to a higher temperature than adsorption, rapid heating and cooling of large amounts of adsorbents may promote the reduction of the amount of the adsorbent usage and equipment size.

Another example is removal of a small fraction of hydrocarbon molecules from a large volume of process streams, such as air and stripping gas. Gas streams of low concentrations of alcohols may be produced from fermentation, catalytic reaction, and other conversion processes. Hydrogenation or fermentation of CO₂ into alcohols may be considered as one promising conversion route to produce carbon-neutral fuels and chemicals, which typically generates a process stream of low alcohol concentrations. Such alcohols may be captured using a selective adsorbent and recovered as valuable products by regenerating the adsorbent with heating. Air dehumidification may be commonly used in buildings and industrial processes. Solid desiccant or adsorbent may be effective for removal of moisture at high rates, but the adsorbent should be regenerated by heating. In current industrial gas or air-drying processes, the regeneration often takes days due to a low heating and cooling rate of large adsorbent beds. Such slow regeneration may be cost-prohibitive to other new applications.

In contrast to adsorption that involves periodic regeneration, a catalytic reaction may be a steady-state process. The catalytic reaction may be an endothermic reaction or an exothermic reaction. For example, hydrogenation of CO or CO₂ into hydrocarbons may be exothermic reactions, and the resulting heat may be removed to avoid byproduct formation and catalyst deactivation.

A thermal energy storage (TES) function may be integrated into heat exchangers through the incorporation of some functional materials with thermal energy storage capacity, such as phase change materials (PCM). For example, the addition of the TES function may reduce the energy consumption of building air conditioning by utilizing changes of weather temperature. For example, PCM material in a solid state may be heated and melted into a liquid state when there is excessive heat available during day time. The PCM material may release the heat and maintain the air temperature in instances in which the temperature of the PCM material falls below a solidification point of the PCM. Such a device may include 1) large volume fraction of the PCM material, 2) rapid heat transfer between the process fluid (air or water) and the PCM material, and 3) rapid heat transfer between the PCM and a thermal fluid (e.g., heating or cooling fluid).

Various fluid/solid contactors or reactors have been developed and commercialized, including axial flow packed beds, radial flow packed bed, shallow packed beds, fluidized beds, and moving beds. The heat exchanging tubes may be inserted inside these beds to provide a heat transfer. However, conventional reactors may be cost prohibitive for use in the above-described applications that require high loading of active materials, rapid mass transfer, rapid heat transfer, and low pressure drops—all these performance attributes.

Material structures and devices have been developed to mitigate the above problems. For example, functional materials (adsorbent, sorbents, catalysts) may be made into sheets, plates, or monolith forms to address issues of mass transfer and pressure drops. However, the heat transfer and adsorbent loading problems may not be well addressed by changing form factors of the functional material. Heat transfer rate from bulk gas to the solid material may be very slow due to poor thermal conductivity of gas and the solid material. Properties of the functional materials may be changed during the forming process, such as coating, extrusion, and casting. For example, pores of the functional materials may be blocked by binders and additives, and active functional sites may be poisoned or deactivated by some impurities generated during the forming process. In other devices, the heat transfer, pressure drop, and mass transfer issues may be mitigated by coating the functional material on the heat exchanger and fins. For example, desiccant material may be formed as a coating on the thin fins of a heat exchanger to obtain a large mass transfer area (and rate), rapid heat transfer, and low pressure drops for fast drying of large volume of gas flow. Oxidation catalysts may be coated on the heat exchanger fins for destruction of hydrocarbon pollutants by oxidation and recovery heat of the reaction. However, this approach may be limited by the type of material and thickness of the coating that can be actually made. The coating layer may crack or delaminate if the coating gets thick, such as, greater than about 50 μm. In addition, molecular diffusion rate and activity of the functional material may tend to degrade when made into coatings.

One or more embodiments may include a device having an integrated mass and/or heat transfer (IMHX) structure. The term “mass and/or heat transfer” may be used in the present disclosure to describe a structure or process that may perform only mass transfer, only heat transfer or both mass and heat transfer. Thus, the IMHX structure may describe a structure configured to perform only mass transfer, only heat transfer or both mass and heat transfer.

The IMHX structure may include two sets of material structures contacting each other in alternate patterns, including two sets of flow channels for respective process fluid and thermal fluid (or exchange fluid). Hydraulic diameters may be about 0.3 mm to 3.0 mm for the process flow channel and about 1 mm to 30 mm for the thermal flow channel. The IMHX structure may include a mass and/or heat transfer (MHX) plate for enhancing mass transfer and/or heat transfer at low pressure drops for adsorption, reaction, and thermal processes. A functional material (adsorbent, sorbent, catalyst, thermal storage material, etc.) may be encapsulated in the MHX plate of high thermal conductivity at significant volume loading fraction for mass transfer and/or heat transfer between the process fluid and the functional material. Heat exchange tubes (heat transfer tubes or HX tubes) may be disposed on the MHX plate for heat transfer between the thermal fluid and the functional material by thermal conduction. The device may enable fast heating and cooling of a large volume of the adsorbent material during respective desorption and adsorption process, where heat of adsorption may become significant. Application of the device to adsorption processes may be illustrated with CO₂ capture from air, where heating up of the saturated adsorbent may be important for regeneration. The embodiment devices may also be used to control the catalyst temperature during an endothermic or exothermic reaction process.

In one or more embodiments, the MHX plate may include a thermally conductive supporting matrix having a thickness of about 0.2 mm to 5 mm with thermal conductivity greater than 10 W/(m·K). The functional materials (adsorbent, sorbent, catalyst or thermal storage material) may be encapsulated in the thermally conductive supporting matrix. In one or more embodiments, the heat exchange tubes and MHX plates may be disposed in such a way that heat transfer between the thermal fluid and functional material may be conducted rapidly by thermal conduction, process stream flows over the MHX plate at low pressure drops, and molecules can rapidly transport from the process flow to the functional material by diffusion. The heat exchange tubes and MHX plates may be made of materials with high thermal conductivity, such as aluminum, copper, metal alloys, graphite, etc. A significant volume fraction of the MHX plate may be taken by the functional material, preferably in a range from 0.2 to 0.8. In at least one embodiment, the volume fraction may be in a range from 0.2 to 0.9. The device including the IMHX structure may include only a few components with simple structures and may enable low-cost production by automated manufacturing and assembly of a small number of standard parts.

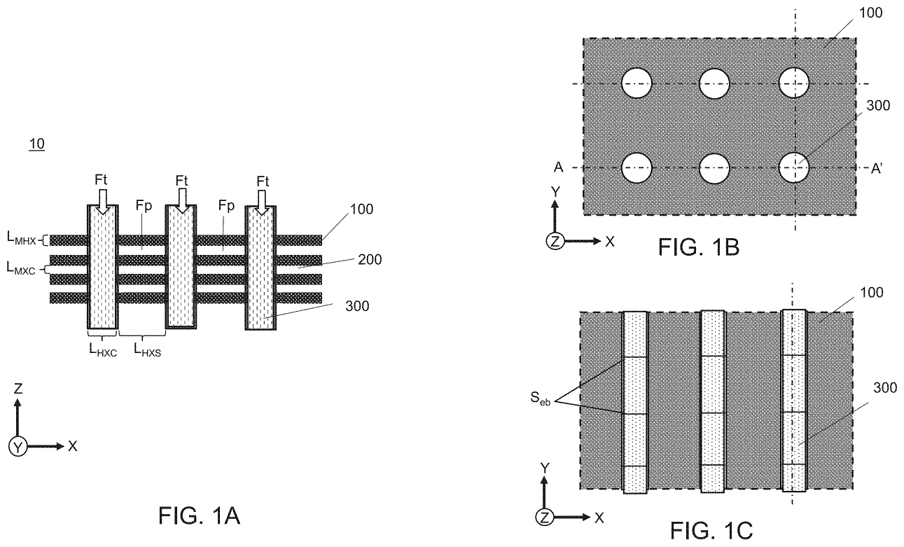

FIGS. 1A-1C are schematic diagrams of an integrated mass and/or heat transfer (IMHX) structure 10 (IMHX module, IMHX device, etc.) with a perpendicular configuration, according to one or more embodiments. In particular, FIG. 1A is a vertical cross-sectional view of MHX plate 100 stacking (e.g., MHX plate stack) along line A-A′ in FIG. 1B, according to one or more embodiments.

As illustrated in FIG. 1A, a set of heat exchange (HX) tubes 300 (e.g., a channel (tube) for thermal fluid Ft) may be disposed vertically (e.g., in the z-direction) while a set of MHX plates 100 (e.g., mass and/or heat transfer plate) may be disposed horizontally (e.g., in the x-direction). A process flow channel 200 may include a straight channel and may be formed by the spacing created between the MHX plates 100 for process flow. The process flow channel 200 may also be referred to as a channel for process flow, a mass transfer channel or a mass exchange channel. The hydraulic diameter for the process flow channel 200 may be, for example, about 0.3 mm to 3 mm. The fabrication cost and pressure drop may become too high as the channel decreases in size. In contrast, the mass and/or heat transfer rate may be too slow as the channel increases in size. The process flow channel 200 may have a length in the z-direction of L_{MXC} and a length in the x-direction of L_{HXS} (e.g., the process flow channel 200 may be characterized with dimensions of L_{MXC} and L_{HXS}). Considering fabrication costs, heat and mass transfer rates, and process flow pressure drops, L_{MXC} may be preferably about 0.3 mm to about 3.0 mm, and L_{HXS} may be preferably about 20 mm to about 200 mm. A flow direction of the process fluid Fp may be in the process flow channel 200 in the x-direction and/or y-direction in FIG. 1A.

It should be noted that while the drawings may show the IMHX structure 10 as including a plurality of MHX plates 100 with a plurality of heat exchange tubes 300, the IMHX structure 10 is not so limited. In particular, the IMHX structure 10 may include a single MHX plate 100 with a single heat exchange tube 300. The IMHX structure 10 may include a single MHX plate 100 with a plurality of heat exchange tubes 300. The IMHX structure 10 may also include a plurality of MHX plates 100 with a single heat exchange tube 300.

The size of the HX tubes 300 may be characterized by their hydraulic diameter L_{HXC} which may be preferably about 1 mm to 30 mm. In at least one embodiment, the hydraulic diameter L_{HXC} may be from 1 mm to 5 mm. A thickness of the MHX plate 100 may be characterized by dimension of L_{MHX} and may preferably be 0.3 mm to 5.0 mm. In at least one embodiment, a thickness of the MHX plate 100 may be from 0.5 mm to 5 mm. Spacing between the HX tubes 300 (e.g., a thermal conduction distance) may be characterized by L_{HXS} and may be preferably about 2 cm to 20 cm. The thermal fluid Ft (e.g., heat transfer fluid) may be used to provide or remove heat from the functional material encapsulated in the MHX plates 100 by thermal conduction between the HX tubes 300 and the MHX plates 100 (e.g., heat exchange between the thermal fluid Ft and the MHX plates 100). Thermal conductivity of the HX tubes 300 and MHX plates 100 may be preferably greater than 5 W/(m·K), more preferably greater than 20 W/(m·K).

As the process fluid Fp flows in the process flow channels 200 between the MHX plates 100 (e.g., in the x-direction and/or y-direction), mass transport between the process fluid Fp and functional material may occur by molecular diffusion (e.g., mass and/or heat exchange between the process fluid Fp and the MHX plates 100). To have rapid mass transfer, the MHX plate 100 should not be too thick and spacing between the MHX plates 100 should not be too large. The MHX plates 100 should be thick enough to have high loading of the functional material and keep proper mechanical strength. A thickness of 0.3 mm to 5.0 mm may be preferred. The process flow channels 200 in the spacing between the MHX plates 100 may allow the process fluid Fp to flow through at low pressure drop. To have small pressure drops and high mass and heat transfer rate, the spacing may be preferred to be 0.3 mm to 3 mm.

The thermal conduction rate between the HX tubes 300 and MHX plates 100 may increase with decreasing spacing between the HX tubes 300. However, reducing the HX tube spacing may result in a decrease of working area of the MHX plate 100 and high fabrication cost. The thermal conduction rate may also increase with thermal conductivity of the MHX plate 100. The thermal conductivity may be determined by economics of available materials. Aluminum, copper, and steel are common and inexpensive materials with high thermal conductivity. Considering most practical application conditions, the HX tube spacing (e.g., L_{HXS}) may preferably be about 2 cm to 20 cm.

FIG. 1B is a plan view of the MHX plate 100 (e.g., mass and/or heat transfer plate) with rounded HX tubes 300 (e.g., heat transfer channel), according to one or more embodiments. As illustrated in FIG. 1B, the HX tubes 300 may be rounded tubes that may be commonly available with diameters from 6 mm to 30 mm. FIG. 1C is a plan view of the MHX plate 100 with rectangular HX tubes 300, according to one or more embodiments. As illustrated in FIG. 1C, the HX tubes 300 may also be in rectangle tubes with width of 3 mm to 30 mm and enforcement beam spacing S_{eb} of about 3 mm to 30 mm, which may correspond to hydraulic diameter of about 3 mm to 30 mm.

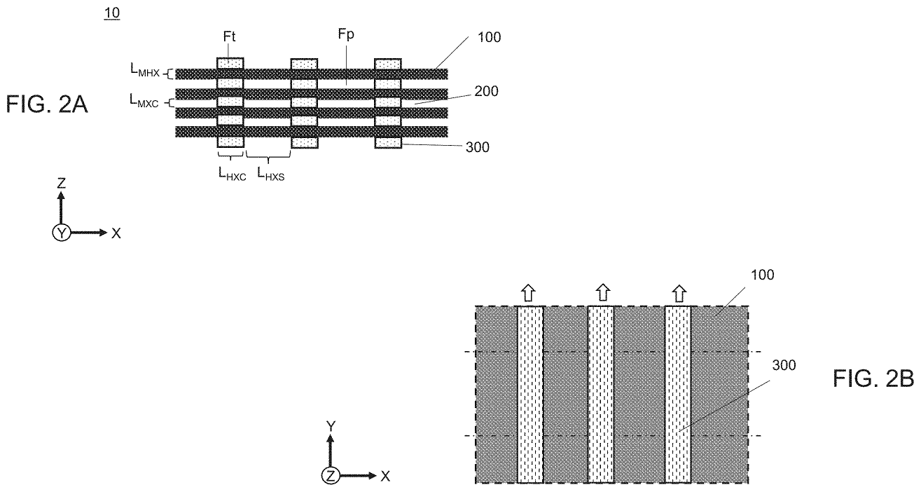

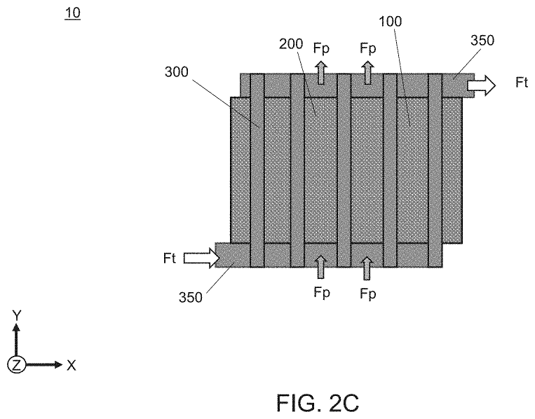

FIGS. 2A-2C are schematic diagrams of an IMHX structure 10 with a parallel configuration, according to one or more embodiments. In particular, FIG. 2A is a cross-sectional view of MHX plate stacking (e.g., MHX plate stack), according to one or more embodiments.

As illustrated in FIG. 2A, the MHX plates 100 and HX tubes 300 (e.g., channel for thermal fluid Ft) may be disposed in a parallel configuration. That is, the MHX plates 100 and HX tubes 300 may be formed in parallel planes. For example, in FIG. 2A, the MHX plates 100 may be formed in an x-y plane and the HX tubes 300 may be formed in an x-y plane that is parallel to the x-y plane of the MHX plates 100. In this embodiment, a flow direction of the thermal fluid in the HX tubes 300 may be in the y-direction (e.g., into the page). The process fluid Fp may be flowed between the MHX plates 100 and between the HX tubes 300 in the y-direction (e.g., into the page). Heat exchange may occur between the thermal fluid Ft and the MHX plates 100, and mass and/or heat exchange may occur between the process fluid Fp and the MHX plates 100.

The MHX plates 100 and HX tubes 300 may be stacked alternatively to form the process flow channel 200. To maximize the contacting area between the HX tube 300 and MHX plate 100, a rectangle HX tube 300 may preferably have a width L_{HXC} (in the x-direction) of 3 mm to 30 mm and height L_{MXC} (in the z-direction) of 0.5 mm to 3 mm, which may result in hydraulic diameter of about 0.5 mm to 3 mm. In this configuration, the process channel spacing (L_{MXC}) may be determined by the heat exchange channel height (e.g., height L_{MXC} of the HX tubes 300). Connections of the individual HX tubes 300 in the IMHX structure 10 with perpendicular configuration (as illustrated in FIGS. 1A-1C) may be simple. The manifold tubes may be laid above the bottom of MHX plate 100 and below the top of MHX plate 100 for respective thermal fluid inlet and outlet without obstructing process flow in the process flow channel 200. In other words, thickness of the manifold tube is close to or less than the MHX plate thickness. The heat exchange tube manifolds in the parallel configuration may need to be properly arranged to render assembly without blocking the process flow channel 200.

FIG. 2C illustrates an example of the manifold connection for the parallel configuration. All the HX tubes 300 on the same layer may be connected to a manifold 350 (e.g., manifold of heat exchange tubes) that may be disposed at the same level as the MHX plate 100 without blocking the process flow channels 200 between the MHX plates 100. FIG. 2B is a plan view of an MHX plate 100 with a rectangular HX tube 300, according to one or more embodiments. FIG. 2C is a plan view of one-layer of the IMHX structure 10 with a manifold 350 connection of individual HX tubes 300, according to one or more embodiments.

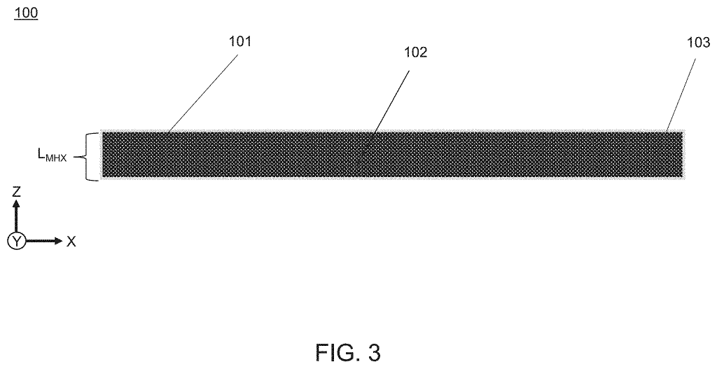

FIG. 3 illustrates components and thickness of an MHX plate 100, according to one or more embodiments. As illustrated in FIG. 3, the MHX plate 100 may include (e.g., consist of) a supporting matrix 101 of high thermal conductivity and mechanical strength, functional material 102 (e.g., active functional material) at volume fraction about 0.2 to 0.80, and an encapsulation medium 103. The thermal conductivity may be greater than 10 W/(m·K) and the thickness may be 0.3 mm to 5.0 mm. In at least one embodiment, the thermal conductivity of the supporting matrix 101 may be greater than 50 W/(m·K). In instances in which the MHX plate is too thin, such as instances in which the MHX plate is formed as heat exchanger fins, amounts of the active functional material loading may be too low and the fabrication cost gets too high. In instances in which the MHX plate is too thick, diffusional mass transfer rate into the MHX plate may become too slow. The supporting matrix 101 may be made of metals with high thermal conductivity, such as aluminum, copper, steel, and other alloys. A volume fraction of the supporting matrix 101 in the MHX plate 100 may be 0.1 to 0.6. In particular, the supporting matrix 101 for the MHX plate 100 may include a perforated metal plate having a plurality of voids (e.g., perforations, openings, holes, etc.) and a metal plate having a plurality of mini-cavities.

The encapsulation medium 103 may improve the immobilization of the functional material 102 in or on the supporting matrix 101 with no or minimal negative impacts on the functional material activity. Both volume and mass fraction of the encapsulation medium 103 may be as small as possible. The volume fraction or weight fraction may be about 0.01 to 0.2. In at least one embodiment, a pore size (e.g., opening size) of the encapsulation medium 103 may be less than 10 μm. The encapsulation medium 103 may be different from binders that are typically used to make coatings, extrudates, or beads of the functional material 102 where the binder may provide mechanical strength of the engineered shape of the functional material 102. A mechanical strength of the MHX plate 100 may be mainly provided by the supporting matrix 101. The encapsulation medium 103 may primarily serve the function of holding the functional material 102 in the supporting matrix 101 without free movement.

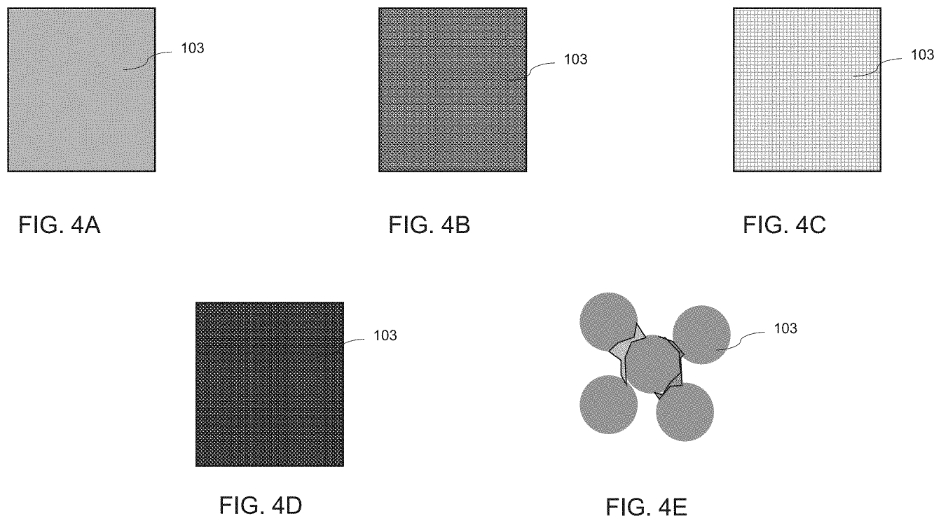

FIGS. 4A-4D illustrate examples of the encapsulation medium 103 (e.g., encapsulation material), according to one or more embodiments. The encapsulation medium 103 may include, for example, a metal mesh, a porous metal membrane, a ceramic membrane, a porous polymer membrane, a metal/ceramic composite membrane, or a metal/polymer composite membrane.

FIG. 4A illustrates the encapsulation medium 103 including a thin dense sheet, according to one or more embodiments. The thin dense sheet may be used to encapsulate the functional material 102 that does not involve molecular exchange with the process fluid, such as thermal storage material.

FIG. 4B illustrates the encapsulation medium 103 including a thin membrane sheet, according to one or more embodiments. The thin membrane sheet may be used to encapsulate the functional material 102 that involves mass transfer with the process fluid. Pore sizes of the membrane may be smaller than particle size of the functional material. In at least one embodiment, a pore size of the encapsulation medium 103 (e.g., thin membrane sheet) may be less than 10.0 μm.

FIG. 4C illustrates the encapsulation medium 103 including a thin mesh (e.g., metal mesh), according to one or more embodiments. In instances in which the particle size of the functional material 102 is relatively large, such as greater than 50 μm, then the thin mesh or screen sheets may be used. In at least one embodiment, a pore size of the mesh may be less than 50 μm. In at least one embodiment, a pore size of the mesh may be less than 100 μm. In at least one embodiment, an open area fraction of the mesh may be greater than 0.3.

FIG. 4D illustrates the encapsulation medium 103 including a thin laminated membrane/mesh sheet, according to one or more embodiments. To have both high mechanical strength and small pores, the thin metal mesh laminated with a thinner membrane may be used. The thickness of encapsulation medium 103 in a sheet of film form may be preferably less than 0.2 mm. In at least one embodiment, a thickness of the encapsulation medium 103 may be less than 0.1 mm. The encapsulation medium 103 may be chemically and thermally stable for long-term operation under application conditions. The metallic sheet and membranes, such as micro-porous nickel alloy and stainless-steel membrane, may possess stability and mechanical strength characteristics but may also tend to have high costs and high density. For low-temperature applications, such as less than 200° C., high-temperature polymeric membrane sheets, such as PTFE membrane may be practical.

Most functional materials, such as catalysts and adsorbents, have the smallest particle sizes down to micrometer level. Thus, micro and ultra-filtration membrane pore sizes are small enough to encapsulate fine powder of the functional materials. In addition to these physical encapsulation media, molecular immobilizers may be used as the encapsulation medium 103.

FIG. 4E illustrates a molecular immobilizer form of encapsulation medium 103, according to one or more embodiments. As illustrated in FIG. 4E, the molecular immobilizer may fix the particle of functional material 102 by capillary force or chemical bonding between the particles. A physical encapsulation medium may be used for functional materials 102 of different chemical compositions, while the molecular immobilizer may be selected for the encapsulation medium 103 based on specific material chemistry of the functional material 102.

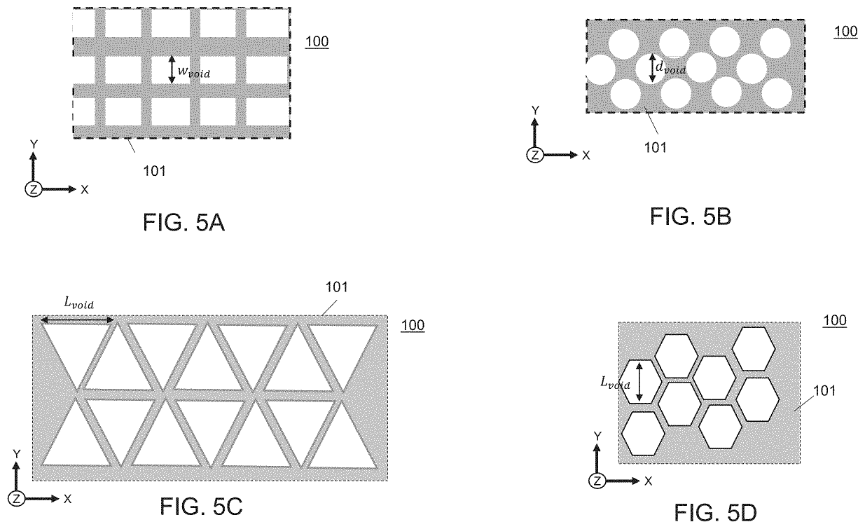

FIGS. 5A-5D illustrate examples of a supporting matrix 101 for the MHX plate 100, according to one or more embodiments. In particular, FIG. 4A illustrates a supporting matrix 101 having a rectangular void, according to one or more embodiments. FIG. 5B illustrates a supporting matrix 101 having a perforated rounded void, according to one or more embodiments. FIG. 5C illustrates a supporting matrix 101 of triangular void, according to one or more embodiments. FIG. 5D illustrates a supporting matrix 101 having a hexagonal void, according to one or more embodiments. The void can be in other shapes, such as cross, diamond, etc. The supporting matrices 101 in FIGS. 5A-5D can be formed with low-cost metal fabrication methods.

The size of the voids in FIGS. 5A-5D may be characterized by hydraulic diameter, Lₕ as defined below:

$${L}_{h} = \frac{4 \cdot Surface area of the hole}{Perimeter of the hole} \qquad ( 1 )$$

Specific interfacial area between the supporting matrix and functional material for thermal conduction is described by the following equations:

$$\begin{matrix}{SA}_{SMF} = \frac{Perimeter of the hole \cdot Thickness}{Surface area of the hole \cdot Thickness} = \frac{4}{{L}_{h}} & ( 2 ) \\ {SA}_{SMF} = \frac{4}{{w}_{void}} for square ( rectangular - shaped ) voids & ( 3 ) \\ {SA}_{SMF} = \frac{4}{{d}_{void}} for rounded voids & ( 4 ) \\ {SA}_{SMF} = \frac{6.9}{{L}_{void}} for triangular voids & ( 5 )\end{matrix}$$

where Lₕ—hydraulic diameter, m; SA_{SMF}=specific area of the supporting matrix/functional material interface to the hole volume, m²/m³; w_{void}=width of the square void, m; d_{void}=diameter of the rounded void, m; L_{void}=length of triangular void, m. Thus, it can be seen that at the same geometric dimension, the triangular void provides more specific area than the square or rounded voids.

Void fraction may be another important design parameter of the supporting matrix 101 and defined as follows:

$${ε}_{SM} = \frac{Volume of void}{Total volume} \qquad ( 6 )$$

For the supporting matrix 101 of uniform porous structures throughout its thickness, its void fraction may be same as the front-open-fraction.

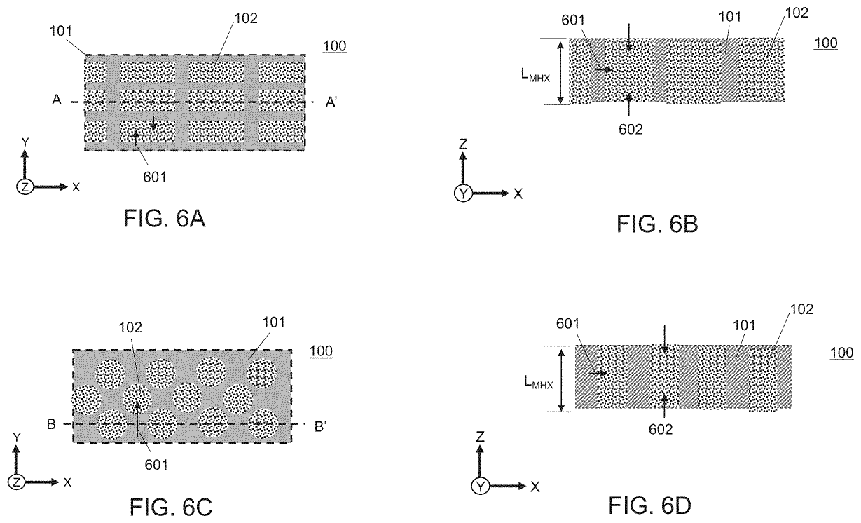

FIGS. 6A-6D illustrate a loading of functional material 102 in the supporting matrix 101 and thermal conduction 601 and molecular diffusion 602, according to one or more embodiments. In particular, FIG. 6A is a plan view of the rectangle slot filled with functional material 102, according to one or more embodiments. FIG. 6B is a cross-sectional view (A-A) of the rectangle slot filled with functional material 102, according to one or more embodiments. FIG. 6C is a plan view of the perforated voids filled with functional material 102, according to one or more embodiments. FIG. 6D is a cross-sectional view (B-B) of the perforated voids filled with functional material 102, according to one or more embodiments.

As illustrated in FIGS. 6A-6D, the functional material 102 may be encapsulated inside the void space of the supporting matrix 101. For example, the functional material 102 in powder or paste form can be used to fill the voids, slots or cavities in the supporting matrix 102. Sizes of the functional material 102 may be substantially less than the opening of void spaces so that the void may be fully and/or densely packed. The functional material 102 may be made of materials with low thermal conductivity, such as porous silica, porous alumina, molecular sieves, resins, and activated carbons. The hydraulic diameter may be as small as possible to increase the specific area for thermal conduction between the supporting matrix and functional material. However, the fabrication cost increases with decreasing the hydraulic diameter of the void in the supporting matrix 101. To compromise these two different desirables, hydraulic diameter of the openings (e.g., voids) in the supporting matrix 101 may be preferably 1 mm to 10 mm, which corresponds to the specific thermal conducting area of 4,000 to 4,00 m²/m³. In at least one embodiment, the hydraulic diameter of the openings (e.g., voids) in the supporting matrix 101 may be from 0.5 mm to 6.0 mm. To enhance thermal conductivity of the encapsulated functional material 102, a fraction of materials with high thermal conductivity may be added to the functional material 102. For example, graphite, carbon fiber, carbon blacks, graphene, carbon nanotubes, aluminum nitride, and silicon carbide may be stable materials with high thermal conductivity. These materials may be added at a small fraction (˜10%) to significantly enhance the thermal conductivity of the functional material packing layer without negative impacting of the functional material activity.

Sizes (e.g., particle sizes) of the functional material 102 may be preferably less than 1 mm, more preferably less than 0.1 mm. As-prepared adsorbents and catalysts may be often in powder or particle form. With the encapsulation method of this disclosure, the functional material can be used to preserve its intrinsic activity and/or selectivity without additional processing, such as coating and extrusion. The present encapsulation method also enables loading of different functional materials in one MHX plate to obtain different functionality. For example, H₂O, CO₂, and volatile organic compounds (VOC) adsorbent particles may be combined to fill the void in the supporting matrix 101 so that these molecules can be removed together.

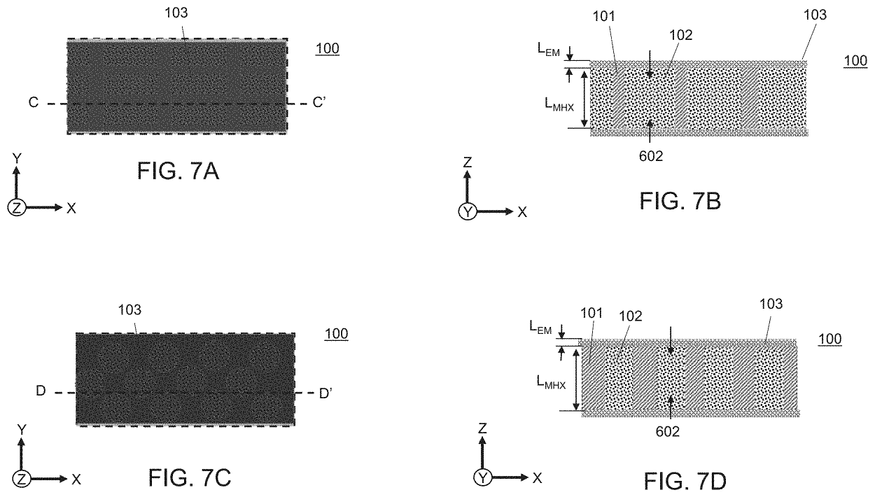

FIGS. 7A-7D illustrate a loading of functional material 102 in the supporting matrix 101 with an encapsulation medium 103, according to one or more embodiments. In particular, FIG. 7A is a plan view of the rectangle slot filled with functional material 102, according to one or more embodiments. FIG. 7B is a cross-sectional view (across C-C′ in FIG. 7A) of the rectangle slot filled with functional material 102, according to one or more embodiments. FIG. 7C is a plan view of the perforated voids filled with functional material 102, according to one or more embodiments. FIG. 7D is a cross-sectional view (across D-D′ in FIG. 7C) of the perforated voids filled with functional material 102, according to one or more embodiments. A ratio of the encapsulation medium thickness (L_{EM}) relative to the supporting matrix thickness (L_{MHX}) is preferably less than 0.2 to minimize usage of the encapsulation medium and diffusional mass transfer resistance.

As illustrated in FIGS. 7A-7D, to assure the functional material 102 be firmly encapsulated, the encapsulation medium 103 may include a thin molecule-permeable encapsulating medium (MPEM) layer attached to bottom and top surface supporting matrix 101 of the MHX plate 100. To minimize weight and molecular diffusion resistance, the MPEM layer thickness may be preferably less than 0.2 mm, more preferably 0.1 mm. To assure that a molecular diffusion resistance through the MPEM layer may be insignificant relative to the diffusion resistance through the MHX plate thickness, molecular permeance of the MPEM layer may be preferably greater than 1×10⁻⁴ mol/(m²·s·Pa). For a porous MPEM layer, its pore size (e.g., opening size) should be small enough to prevent fine particulates inside the MHX plate 100 from leaking out. The pore size may be preferably less than 100 μm, more preferably less than 10 μm. The thin MPEM layer should be durable enough for long-term operation under application conditions. Examples of the MPEM material in the MPEM layer (e.g., the encapsulating medium layer 103) that may be inexpensive and abundant include thin, porous metal sheet, thin metal meshes, thin, porous polymer, and thin, porous fiber-polymer composites. Examples of metallic materials include aluminum, copper, nickel alloy, and steel. Examples of the polymer materials include polytetrafluoroethylene (PTFE), polyether sulfone, polyester, and carbon fiber-polymer composites, which may be durable when subject to periodic cooling and heating.

Selection of proper design parameters for rapid thermal conduction from the HX tube 300 to the MHX plate 100 may optimize their use in practical applications. The thermal conduction rate relative to heat generation or heat sink rate may be selected to be high enough to make the temperature variation on the MHX plate 100 be less than a certain value, such as less 5%. Selection of the design parameters may be guided by the thermal conduction equation.

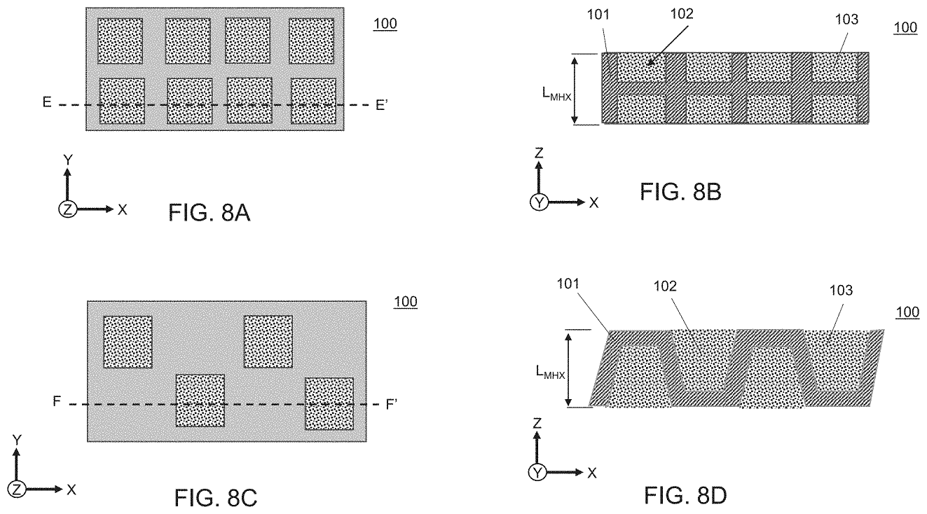

FIGS. 8A-8D illustrate alternative configurations with a supporting matrix 101 formed with arrays of mini-cavities or dimples instead of perforated sheets (plates), according to one or more embodiments. In particular, FIG. 8A is a top down view of the mini-cavities filled with the functional material 102 in a supporting matrix 101 with symmetrical distributions of the micro-cavities on the top and bottom, according to one or more embodiments. FIG. 8B is a cross-sectional view (across E-E′ in FIG. 8A) of such a MHX plate 100, according to one or more embodiments. The functional material 102 may be fixed inside the cavity by use of a molecular immobilizer as the encapsulation medium, according to one or more embodiments.

FIG. 8C is a top-down view of the mini-cavities filled with the functional material 102 in a supporting matrix 101 with alternating micro-cavities on the top and bottom, according to one or more embodiments. FIG. 8D is a cross-sectional view (across F-F′ in FIG. 8C) of the MHX plate 100 illustrated in FIG. 8C, according to one or more embodiments. Diameter and depth of microcavities may be preferred to be about 1 mm to 10 mm and about 0.5 mm to 5.0 mm, respectively. Volume fraction of the micro-cavities in the MHX plate 100 may be preferably to be about 0.4 to 0.8.

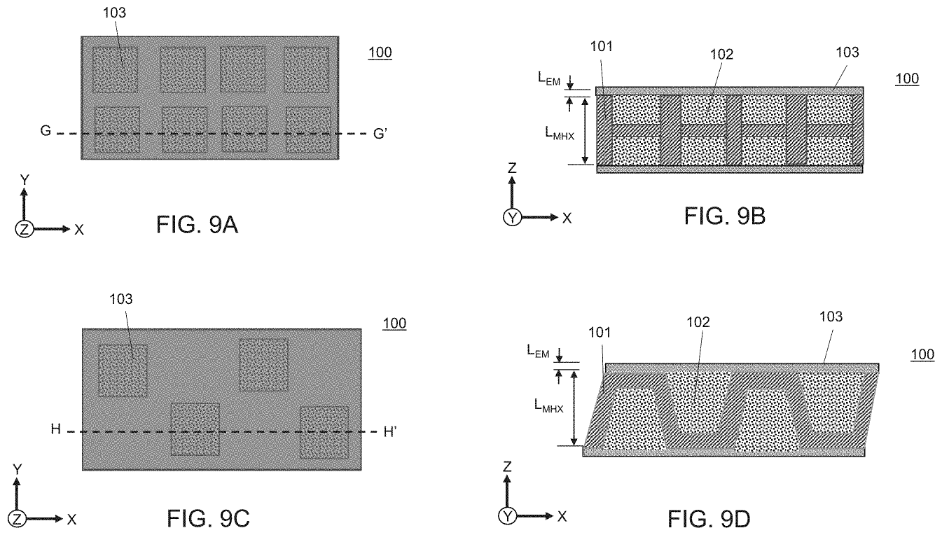

FIGS. 9A-9D illustrate the MHX plate 100 with the same supporting matrix 101 as in FIGS. 8A-8D but with use of a thin encapsulation medium 103. In particular, FIG. 9A is a top down view of the mini-cavities filled with the functional material 102 and covered by a thin encapsulation medium 103 in a supporting matrix 101 with symmetrical distributions of the micro-cavities on the top and bottom, according to one or more embodiments. FIG. 9B is a cross-sectional view (across G-G′ in FIG. 9A) of the MHX plate 100, according to one or more embodiments. Two thin encapsulation media 103 may be placed on top and bottom surfaces of the MHX plate 100 to contain the function material 102.

FIG. 9C is a top-down view of the mini-cavities filled with the functional material 102 and covered with a thin encapsulation medium 103 in a supporting matrix 101 with alternating micro-cavities on the top and bottom, according to one or more embodiments. FIG. 9D is a cross-sectional view (across H-H′ in FIG. 9C) of the MHX plate 100, according to one or more embodiments. In instances in which no mass transfer occurs between the functional material 102 and process fluid Fp, a thin dense sheet may be used as the encapsulation medium 103 and its thickness may be less than about 0.2 mm. To have rapid mass transfer between the functional material 102 and the process fluid Fp, a thin molecule-permeable encapsulating medium (MPEM) may be used with thickness less than 0.2 mm and molecular permeance greater than 1×10⁻⁴ mol/(m²·s·Pa).

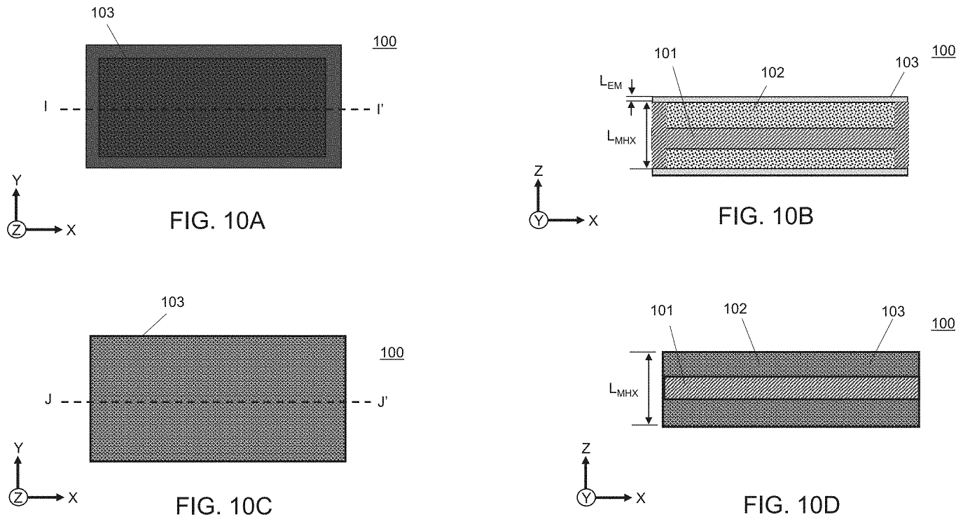

FIGS. 10A to 10D illustrate a simple configuration of an MHX plate 100, according to one or more embodiments. FIG. 10A is a top-down view of a layer of functional material 102 laid down on the supporting matrix 101 (e.g., supporting plate) and covered with the encapsulation medium 103, according to one or more embodiments. FIG. 10B is a cross-sectional view (across I-I′ in FIG. 10A) of the structure, according to one or more embodiments. FIG. 10B shows a symmetrical loading and coverage of the functional material 102 on the top and bottom. A ratio of the encapsulation medium thickness (L_{EM}) to the MHX thickness (L_{MHX}) may be less than 0.2. The encapsulation medium thickness (L_{EM}) may be less than 0.2 mm.

In the structures illustrated by FIGS. 10C and 10D, the functional material 102 may be placed onto the supporting matrix 101 in the form of a functional material sheet by use of molecular immobilizers as the encapsulation medium 103, according to one or more embodiments. FIG. 10C is the top-down view, according to one or more embodiments. FIG. 10D is the cross-sectional view (across J-J′ in FIG. 10C) of the two sheets of the functional material 102 being placed on top and bottom of the supporting matrix 101. Different from coatings of the functional material 102 on the supporting matrix 101, the sheet of functional material 102 (e.g., functional material sheet) may be formed as a separate entity. Thus, the functional material sheet thickness may be independently controlled. The functional material sheet thickness may be preferred to be 0.5 mm to 3 mm. A ratio of the functional material sheet thickness to the MHX thickness may be preferably 0.5 to 0.9.

In the above description, the encapsulation sheet may be attached to the MHX plate 100 by mechanical interlock, adhesion, or welding.

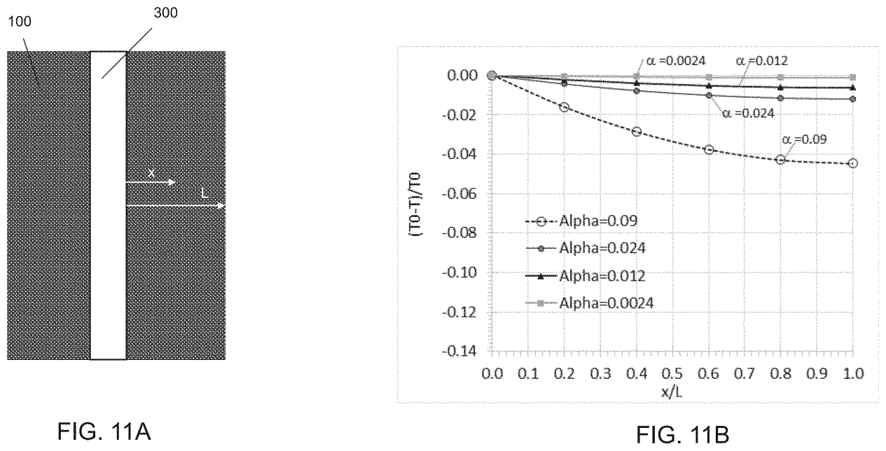

Impacts of the MHX thermal conductivity on heat transfer may be described by heat transfer modeling. FIGS. 11A-11B illustrate a temperature distribution in the IMHX structure 10 (e.g., see FIGS. 1A and 2A) with rectangular HX tubes 300, according to one or more embodiments. In particular, FIG. 11A illustrates a simplified physical model of the IMHX structure 10 with rectangular HX tubes 300, according to one or more embodiments. Thermal conduction from a rectangular HX tube 300 to the MHX plate 100 in FIG. 11A may be approximately described by the following one-dimensional equation:

$$\begin{matrix}( \frac{{d}^{2} T}{{dx}^{2}} ) = \frac{1}{{k}_{MHX}} {r}_{q} \\ Let & ( 7 ) \\ ξ = \frac{x}{I} & ( 8 ) \\ θ = \frac{T - {T}_{o}}{{T}_{o}} & ( 9 ) \\ α = \frac{{L}^{2}}{{k}_{mhx} \cdot {T}_{0}} {r}_{q} \\ Then & ( 10 ) \\ \frac{{d}^{2} θ}{d {ξ}^{2}} = α & ( 11 )\end{matrix}$$

Where T₀ is the temperature at interface of the HX tube/supporting matrix, K; T is the temperature on the MHX plate 100 at distance of x from the interface, K; x is the distance from the interface, m; k_{MHX} is thermal conductivity of the MHX plate 100, W/(m·K); L is half of the spacing between the HX tube 300 on the supporting matrix, m; r_{q}=heat sink rate, W/m³.

Relationship of the MHX plate thermal conductivity with the supporting matrix 101 and functional material 102 may be approximately described by the following equation:

k_{MHX}=εₛₘkₛₘ+εₛkₛ==(1−εₛ)kₛₘ+εₛkₛ (12)

Where kₛₘ is thermal conductivity of the supporting matrix 101, W/(m·K); kₛ is thermal conductivity of the function material 102, W/(m·K); εₛ=volume fraction of the functional material 102 in the MHX plate 100. Since the functional material 102 may be typically made of metal oxide or ceramic-type materials, its thermal conductivity may be low. The supporting matrix 101 may be made of materials with high thermal conductivity. Desirable volume fraction of the function material 102 in the MHX plate 100 may be as high as possible. Certain volume fraction of the supporting matrix may be important for having adequate thermal conductivity and mechanical strength. εₛ may be preferably to be 0.2 to 0.8.

For molecule desorption from a sorbent, the heat sink rate can be described by the following equation:

$${r}_{q} = {ε}_{s} {ρ}_{s} \frac{{w}_{s}}{MW} \frac{Δ H}{{t}_{des}} \qquad ( 13 )$$

Where εₛ=volume fraction of the sorbent in the MHX plate 100; ρₛ=packing density of the sorbent in the MHX plate 100, kg/m³; wₛ=adsorption capacity of the sorbent, Kg/Kg; MW=molecular weight of the desorbing molecule, Kg; ΔH=heat of desorption, J/mol; t_{eds}=desorption time, s.

For heating up of the MHX plate 100, the heat sink rate can be described by the following equation:

r_{q}=ρₘₕₓC_{p,mhx}r_{T} (14)

where ρₘₕₓ=density of the MHX plate, kg/m³; C_{p,mhx}=specific heat capacity of the MHX plate 100, J/kg/K; r_{T}=heating rate, K/s.

FIG. 11B is a graph illustrating temperature variation along distance of the MHX plate 100, according to one or more embodiments. In particular, an impact of parameter α on temperature variations may be illustrated in FIG. 11B. If parameter α is less than 0.09, temperature variation along the whole thermal conducting length may be less than 5%. If T₀=350K, the temperature variation may be less than 16.5K. The temperature variation can be lowered to less than 1% when a is 0.012. Table 1 lists α values (e.g., design conditions) for a few sets of design conditions for the IMHX structure 10 having a rectangular HX tube 300. At spacing of 0.1 m from the surface of the HX tube 300, thermal conductivity of the MHX plate 100 may need to be greater than 20 W/(m·K) to make a value below 0.09 for both desorption and sensible heating.

TABLE 1
Design parameters of the IMHX for heat transfer between the rectangle
heat exchange tube and MHX plate by thermal conduction

| | | | | | | |
|---|---|---|---|---|---|---|
| T₀, K | 373 | 373 | 373 | 373 | 373 | 373 |
| Spacing (L), m | 0.1 | 0.1 | 0.1 | 0.05 | 0.05 | 0.05 |
| Properties of MHX plate | | | | | | |
| Thermal conductivity, W/(m · K) | 10 | 20 | 100 | 10 | 20 | 100 |
| Density, kg/m³ | 2000 | 2000 | 2000 | 2000 | 2000 | 2000 |
| Specific heat capacity, kJ/(kg · K) | 1 | 1 | 1 | 1 | 1 | 1 |
| Desorption | | | | | | |
| Sorbent vol fraction | 0.5 | 0.5 | 0.5 | 0.5 | 0.5 | 0.5 |
| Sorbent density, kg/m³ | 800 | 800 | 800 | 800 | 800 | 800 |
| Adsorption capacity, g/g | 0.05 | 0.05 | 0.05 | 0.05 | 0.05 | 0.05 |
| Molecular weight, kg | 0.044 | 0.044 | 0.044 | 0.044 | 0.044 | 0.044 |
| Desorption time, s | 1,000 | 1,000 | 1,000 | 1,000 | 1,000 | 1,000 |
| Heat of desorption, J/mol | 80,000 | 80,000 | 80,000 | 80,000 | 80,000 | 80,000 |
| alpha value | 0.097 | 0.049 | 0.010 | 0.024 | 0.012 | 0.002 |
| Sensible heating | | | | | | |
| Heating rate, K/s | 0.13 | 0.13 | 0.13 | 0.13 | 0.13 | 0.13 |
| alpha value | 0.715 | 0.357 | 0.071 | 0.179 | 0.089 | 0.018 |

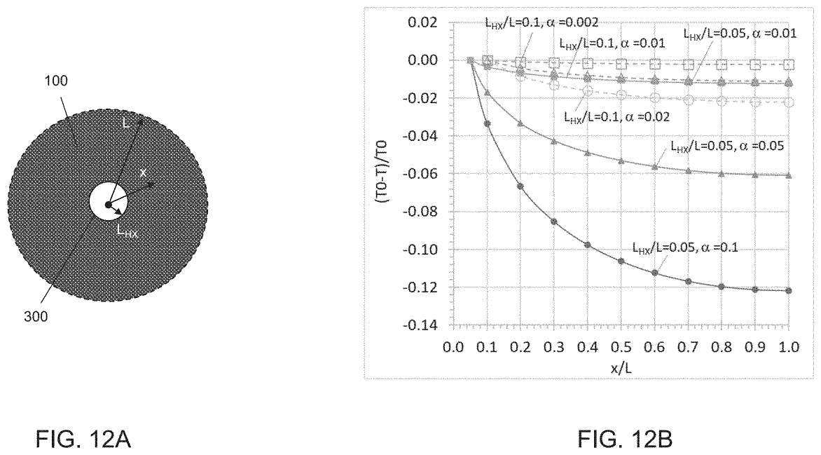

FIGS. 12A-12B illustrate a temperature distribution in the IMHX structure 10 with rounded HX tube 300, according to one or more embodiments. In particular, FIG. 12A illustrates a simplified physical model of the IMHX structure 10 with rounded HX tube 300, according to one or more embodiments. In FIG. 12A, heat transfer from the rounded HX tube 300 to the MHX plate 100 may be approximately described by the following equation:

$$\frac{d}{d ξ} ( ξ \frac{d ↓}{d ξ} ) = α \cdot ξ \qquad ( 15 )$$

The definition of variables and parameter α may be the same as above. Based on Equation (15), temperature variations along the distance from the HX tube centerline may be calculated.

FIG. 12B is a graph illustrating temperature variation (calculated using Equation (15)) along distance of the MHX plate 100, according to one or more embodiments. As illustrated in FIG. 12B, the parameter α may need to be less than 0.05 to have the temperature variation less than 5%.

Table 2 below lists design conditions for the integrated mass and/or heat transfer (IMHX) structure 10 with rounded heat exchange (HX) tubes 300. In particular, Table 2 lists α values with different MHX plate thermal conductivity for two thermal conducting lengths (0.1 m and 0.05 m). α values can be less than 0.05 for most desorption design conditions. However, α value less than 0.05 may only be obtainable with the MHX plate 100 of thermal conductivity 100 W/(m·K) and conducting length of 0.05 m among the 6 sets of sensible heating conditions given. The α value can be proportionately decreased by shortening a length of the thermal conducting zone on the MHX plate 100. However, the number of HX tubes 300 required, and fabrication cost may likely increase.

TABLE 2
Design parameters of the IMHX for heat transfer between the rounded
heat exchange tube and MHX plate by thermal conduction

| | | | | | | |
|---|---|---|---|---|---|---|
| T₀, K | 373 | 373 | 373 | 373 | 373 | 373 |
| HX tube radius (L_{HX}), m | 0.005 | 0.005 | 0.005 | 0.005 | 0.005 | 0.005 |
| Radius of thermal conducting | 0.1 | 0.1 | 0.1 | 0.05 | 0.05 | 0.05 |
| zone (L), m | | | | | | |
| Properties of MHX plate | | | | | | |
| Thermal conductivity, W/(m · K) | 10 | 20 | 100 | 10 | 20 | 100 |
| Density, kg/m³ | 2000 | 2000 | 2000 | 2000 | 2000 | 2000 |
| Specific heat capacity, kJ/(kg · K) | 1 | 1 | 1 | 1 | 1 | 1 |
| Desorption | | | | | | |
| Sorbent vol fraction | 0.5 | 0.5 | 0.5 | 0.5 | 0.5 | 0.5 |
| Sorbent density, kg/m³ | 800 | 800 | 800 | 800 | 800 | 800 |
| Adsorption capacity, g/g | 0.05 | 0.05 | 0.05 | 0.05 | 0.05 | 0.05 |
| Molecular weight, kg | 0.044 | 0.044 | 0.044 | 0.044 | 0.044 | 0.044 |
| Desorption time, s | 1,000 | 1,000 | 1,000 | 1,000 | 1,000 | 1,000 |
| Heat of desorption, J/mol | 80,000 | 80,000 | 80,000 | 80,000 | 80,000 | 80,000 |
| alpha value | 0.097 | 0.049 | 0.010 | 0.0244 | 0.0122 | 0.0024 |
| Sensible heating | | | | | | |
| Heating rate, K/s | 0.13 | 0.13 | 0.13 | 0.13 | 0.13 | 0.13 |
| alpha value | 0.715 | 0.357 | 0.071 | 0.1787 | 0.0894 | 0.0179 |

High thermal conductivity of the MHX plate 100 may be important to having small temperature variations. Table 3 below lists thermal conductivity of common metallic materials and functional materials (e.g., common materials for design consideration). Porous silica and alumina of high BET surface may be commonly used to prepare adsorbents and catalysts. Their thermal conductivity may be very low. The supporting matrix 101 of high thermal conductivity may be needed. Aluminum and pure copper may have high thermal conductivity and may be inexpensive. These two metals may be preferred supporting matrix material. Copper density may be three times that of aluminum and its specific heat capacity may be also 60% higher than aluminum. Aluminum may be a preferred supporting material to reduce weight and thermal mass. With an aluminum supporting matrix 101, the MHX plate 100 may have thermal conductivity of about 100 W/(m·K) at void fraction of 0.55 for loading of the functional material 102.

TABLE 3
Thermal conductivity of common materials

| | | Thermal | | Specific heat |
|---|---|---|---|---|
| | Temperature, | conductivity, | Density, | capacity, |
| Metal | ° C. | W/(m · K) | g/cm³ | kJ/kg · K |
| Aluminum | −73 to 527 | 220-240 | 2.7 | 0.9 |
| Aluminum | 0 to 25 | 150 to 190 | | |
| alloy | | | | |
| Copper | −73 to 527 | 371 to 413 | 8.96 | 1.46 |
| Copper alloy | 20 | 50 to 120 | | |
| Nickel | −73 to 527 | 67 to 106 | | |
| Silver | −73 to 527 | 389 to 403 | | |
| Steel | 20 | 36 to 50 | 7.8 | 0.88 |
| Stainless | 20 | 14 | 7.9 | 0.5 |
| steel | | | | |
| Silica gel | 20 to 100 | 0.12 to 0.5 | | |
| Mesoporous | 300 | 0.15 to 0.7 | | |
| alumina | | | | |
| Air | 20 | 0.025 | | |

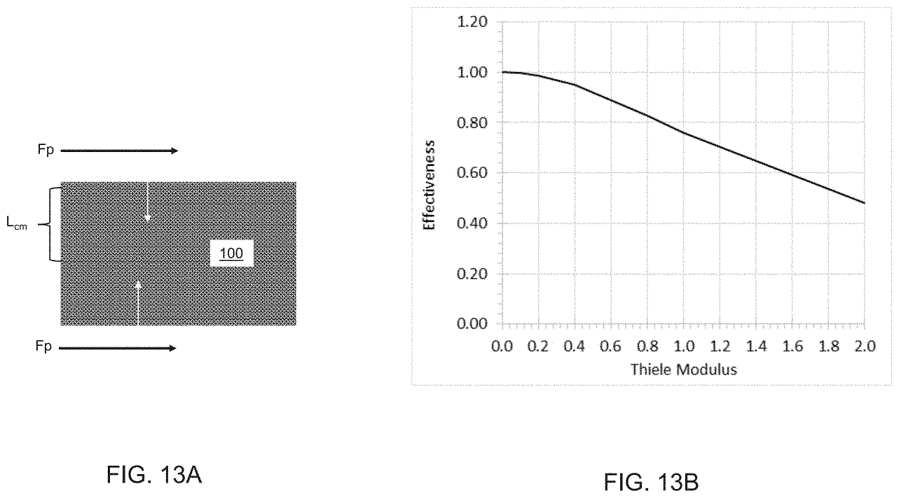

Diffusional mass transfer from the process fluid Fp (e.g., process flow) to the functional material 102 inside the MHX plate 100 may be another important design factor. FIGS. 13A-13B illustrate diffusional mass transfer from process flow to functional material 102 inside the MHX plate 100, according to one or more embodiments. In particular, FIG. 13A illustrates a simplified physical model of the MHX plate 100, according to one or more embodiments. An impact of design and process parameters may be delineated using the one-dimensional model illustrated in FIG. 13A. Assume that adsorption or reaction rate may be approximated by an apparent first order kinetics:

rᵢ=kₐₚₚCᵢ (16)

Mass transfer inside the MHX plate 100 may follow Fick's diffusion equation:

$${J}_{i} = - {D}_{eff} \frac{{dC}_{i}}{dx} \qquad ( 17 )$$

The adsorption or reaction rate throughout the MHX plate thickness may be described as follows:

rᵢ=kₐₚₚC₀·θ (18)

θ is an effectiveness factor and can be calculated by the following equation:

$$θ = \frac{1}{ϕ} \cdot \frac{exp ( ϕ ) - exp ( - ϕ )}{exp ( ϕ ) + exp ( - ϕ )} \qquad ( 19 )$$

ϕ is Thiele Modulus and may be defined as follows:

$$∅ = {{L}_{cm} ( \frac{{k}_{app}}{{D}_{eff}} )}^{0.5} \qquad ( 20 )$$

where rᵢ=disappearance rate of molecule i, mol/(s·m³); kₐₚₚ=apparent rate constant, 1/s; Cᵢ=concentration of molecule i, mol/m³; Jᵢ=diffusion flux of molecule i, mol/(s·m²); D_{eff}=effective diffusivity of molecule i in the MHX plate 100, m²/s; x=diffusion distance, m; C₀=concentration of molecule i at interface of the MHX plate 100 with process flow, mol/m³; L_{cm}=characteristic mass transfer dimension, m. Lcm may be half of the thickness of the perforated MHX plate 100.

FIG. 13B is a graph illustrating an effectiveness factor of the MHX plate 100, according to one or more embodiments. In particular, FIG. 13B is a plot of effectiveness at different values of Thiele Modulus (ϕ). At ϕ=1, effectiveness factor may be about 0.75. At ϕ=2, effectiveness factor may be about 0.5, i.e., only half of the functional material in the MHX plate 100 may be utilized. Thus, for practical application, Thiele Modulus may be preferably less than 2 or 1. Thiele Modulus may be determined by rate constant, effective diffusivity, and thickness of the MHX plate 100. CO₂ diffusivity in air may be 1.6×10⁻⁵ m²/s. Assume volume fraction of the functional material 102 in the MHX plate 100 may be 0.6 and void fraction in the encapsulated functional material 102 may be 0.35. Effective CO₂ diffusivity may be about 3.4×10⁻⁶ m²/s. Thiele Modulus may be 1.1 when the MHX plate thickness is 2 mm and rate constant is 4 1/s. For a given molecule-functional material system, MHX plate thickness may be the main determining parameter to effectiveness.

For most practical applications, high loading of the functional material 102 in the IMHX structure 10 may be desired to obtain high processing capacity per unit volume of the device (e.g., IMHX structure 10). The determining parameters to the functional material loading fraction are illustrated with the IMHX configuration shown in FIG. 2A and described by the following equation:

$${ε}_{device} = \frac{{L}_{MHX} \cdot {L}_{HXS} \cdot {ε}_{MHX} \cdot θ}{( {L}_{MHX} + {L}_{MXC} ) \cdot ( {L}_{LHC} + {L}_{HXS )}}$$

Where ε_{device}=volume fraction of active functional material 102 in device (e.g., the IMHS structure 10); L_{MHX}=thickness of the MHX plate 100; L_{HXS}=spacing between the heat exchange tubes 300 on the MHX plate 100; L_{MXC}=spacing between the MHX plates 100 for process flow, i.e., mass exchange channel spacing; L_{HXS}=width of the heat exchange tube 300 exposed on the MHX plate 100; ε_{MHX}=volume fraction of active functional material 102 in the MHX plate 100; θ=effectiveness factor of the MHX plate 100.

The functional material volume fraction in the device can increase with the MHX plate thickness, its volume fraction in the MHX plate 100, and spacing of the heat exchange tubes 300 on the MHX plate 100. However, the MHX plate thickness increase is constrained by effectiveness factor of the MHX plate 100. Increase in the volume fraction in the MHX plate 100 and heat exchange tube spacing is limited by the heat transfer requirement as described above. The functional material volume fraction in the device can increase with decreasing the process channel spacing and decreasing the heat exchange tube width. However, degree of decreasing process channel spacing is limited by the pressure drop requirement and device fabrication cost. Decrease of the heat exchange tube width is constrained by the heat transfer requirement and fabrication cost. For most practical applications, the MHX plate thickness may be preferably 0.5 mm to 5.0 mm, the volume fraction of active functional materials in the MHX plate 100 may be about 0.2 to 0.8, process flow channel spacing may be about 0.3 mm to 3.0 mm, spacing of the heat exchanging tubes on/in the MHX plate 100 may be about 50 mm to 200 mm, width or diameter of the heat exchange tube 300 interfacing with the MHX plate 100 may be about 3 mm to 30 mm.

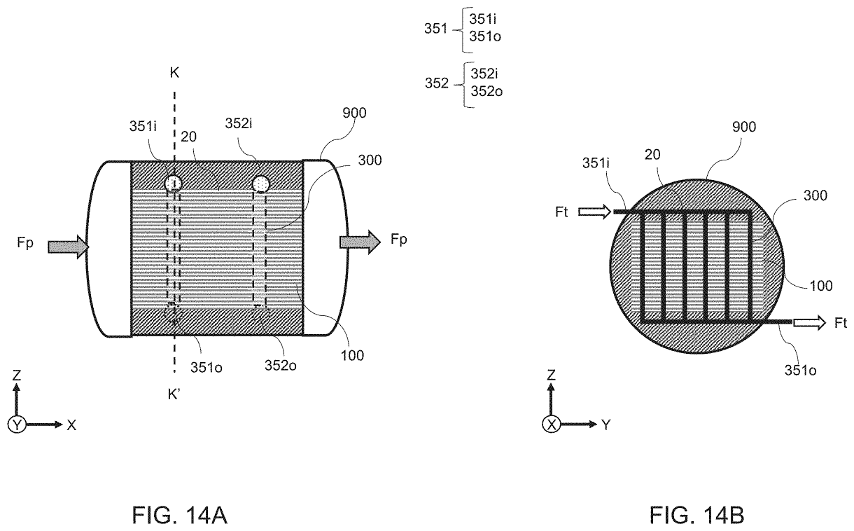

FIGS. 14A-14B provide a vertical cross-sectional view of an IMHX module 20 hosted inside a vessel 900, according to one or more embodiments. The IMHX module 20 may include the IMHX structure 10 placed inside a vessel 900 to meet the pressure and temperature requirements of an application process. In particular, FIG. 14A is a view of the IMHX module 20 along a process flow direction (e.g., x-direction), according to one or more embodiments. FIG. 14A shows the IMHX module 20 placed inside the vessel 900 (e.g., cylindrical vessel). The IMHX module 20 may include one or more MHX plates 100 and one or more HX tubes 300.

In particular, as illustrated in FIG. 14A, the IMHX module 20 may include a first manifold 351 connected to a first set of the HX tubes 300 in contact with the MHX plates 100. The first manifold 351 may include a first manifold inlet 351i connected to a first end (e.g., upper end) of the HX tubes 300 and a first manifold outlet 351o connected to a second end (e.g., lower end) of the HX tubes 300 opposite the first end. The IMHX module 20 may also include a second manifold 351 connected to a second set of the HX tubes 300 in contact with the MHX plates 100. The second manifold 352 may include a second manifold inlet 352i connected to a first end (e.g., upper end) of the HX tubes 300 and a second manifold outlet 352o connected to a second end (e.g., lower end) of the HX tubes 300 opposite the first end. It should be noted that the first manifold outlet 351o and second manifold outlet 352o are shown as dashed lines to indicate that the first manifold outlet 3510 and second manifold outlet 352o may be (but are not necessarily located on the other side of the vessel 900 from the first manifold inlet 351i and second manifold inlet 352i.

As illustrated in FIG. 14A, the process fluid Fp (e.g., process flow) may enter the IMHX module 20 at one end of the cylindrical vessel 900 (flowing in the x-direction) and exit at the other end. In this way, the process fluid Fp may flow through the module 20 in one direction and experience a small pressure drop. The thermal fluid Ft (e.g., hot thermal fluid) may enter the vessel 900 through the first manifold inlet 351i and second manifold inlet 352i (flowing in the y-direction (e.g., into the page)), and exit the vessel 900 through the first manifold outlet 351o and second manifold outlet 352o (flowing in the y-direction (e.g., out of the page)).

FIG. 14B is a view of the IMHX module 20 in a direction perpendicular to the process flow direction, according to one or more embodiments. In particular, FIG. 14B is a vertical cross-sectional view across K-K′ in FIG. 14A and the process flow direction may be in the x-direction (e.g., into the page). As illustrated in FIG. 14B, the thermal fluid Ft (e.g., hot thermal fluid) may enter the vessel 900 through the first manifold inlet 351i on a first side of the vessel 900 and exit the vessel 900 through the first manifold outlet 351o on a second side of the vessel 900 opposite the first side.

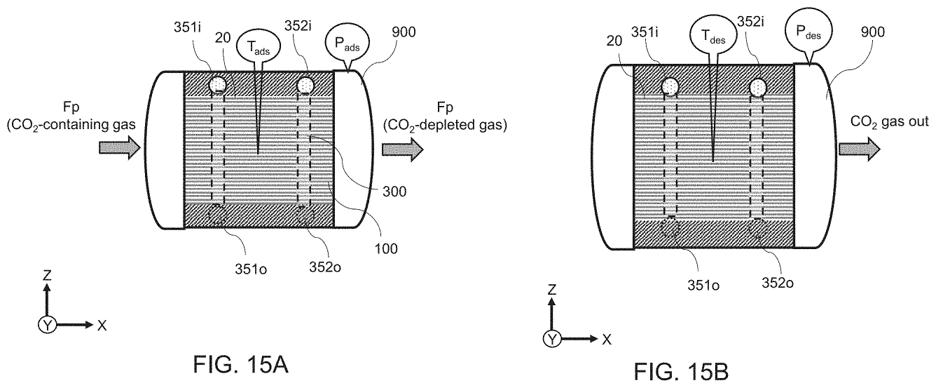

FIGS. 15A-15B illustrate the IMHX module 20 for pressure-swing-adsorption (PSA) and thermal-swing-adsorption (TSA), according to one or more embodiments. In particular, FIG. 15A is a view of the IMHX module 20 for adsorption at high pressure and low temperature in the vessel 900, according to one or more embodiments.

FIG. 15A illustrates the IMHX module 20 being used for CO₂ separation by pressure-swing-adsorption (PSA) and temperature-swing-adsorption (TSA). As illustrated in FIG. 15A, during adsorption, a CO₂-containing process stream Fp may pass through the IMHX module 20 loaded with a CO₂-selective adsorbent (e.g., as a functional material 102 in the MHX plate 100) under adsorption pressure (P_{ads}). To prevent the adsorbent from being heated up, a cold thermal fluid Ft may be introduced through the first manifold inlet 351i and second manifold inlet 352i (flowing in the y-direction (e.g., into the page)), to the HX tube 300 to take away from heat of adsorption during adsorption and control the MHX plate temperature at adsorption temperature (T_{ads}). In at least one embodiment, the adsorption temperature (T_{ads}) may be less than 60° C.

FIG. 15B is a view of the IMHX module 20 for regeneration at low pressure and high temperature, according to one or more embodiments. When the adsorbent is saturated, the vessel 900 (e.g., IMHX vessel) may be switched to regeneration. The process stream Fp may be stopped and the pressure in vessel 900 may be decreased to desorption pressure (P_{des}), less than the adsorption pressure (P_{ads}). Hot thermal fluid Ft may be introduced through the first manifold inlet 351i and second manifold inlet 352i (flowing in the y-direction (e.g., into the page)), to heat up the MHX plate 100 to desorption temperature (T_{des}) to release CO₂ from the adsorbent. The released CO₂ gas may then exit the vessel 900 through the process fluid line that carries the process fluid Fp). The desorption temperature (T_{des}) could be significantly higher than the adsorption temperature (T_{ads}). It should be noted that a sweep fluid (e.g., air) may be introduced to the vessel 900 (e.g., through the process fluid line that carries the process fluid Fp) during the desorption of the adsorbed molecule (e.g., CO₂) from the adsorbent in order to help sweep the molecule out of the vessel 900.

A high-selective adsorbent may often be associated with large heat of adsorption. It may be important to remove heat during adsorption and provide heat during desorption in order to preserve the adsorbent activity and maintain high productivity. Heating and cooling of a large vessel with conventional designs may be slow. With the IMHX module 20, the adsorbent material may be heated or cooled by the thermal fluid Ft so that regeneration can be completed within a short period (e.g., less than 1 hour).

The IMHX module 20 may provide large benefits to adsorption separation of low concentration of molecules from process streams of large volume flow rate, such as, CO₂ capture from flue gas, recovery of hydrocarbons, etc. Gas streams of low alcohol concentration (<10 vol. %) can be produced by various chemical, biological, and electrochemical conversion processes. The capital and energy costs may be fairly high to recover these alcohols using conventional separation technologies. The IMHX module 20 loaded with alcohol-selective adsorbents (e.g., as a functional material 102 in the MHX plate 100) may substantially reduce the capital cost and energy consumption.

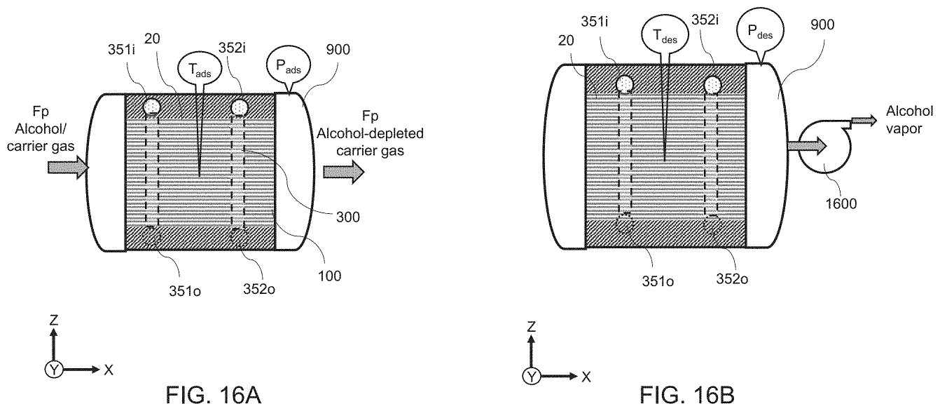

FIGS. 16A-16B illustrate an application of IMHX module 20 loaded with alcohol-selective adsorbent material (e.g., as functional material 102 in the MHX plate 100) to recovery of alcohols from dilute process streams, according to one or more embodiments. In particular, FIG. 16A is a view of the IMHX module 20 for performing adsorption at process pressure and temperature in the vessel 900, according to one or more embodiments. As illustrated in FIG. 16A, the process fluid Fp (e.g., process stream) containing low concentration alcohols may be introduced into the vessel 900. The alcohol may be captured on the alcohol-selective adsorbent at the process temperature (T_{ads}) and pressure (P_{ads}). In at least one embodiment, the adsorption temperature (T_{ads}) may be less than 60° C.

To prevent the adsorbent from being heated up, a cold thermal fluid Ft may be introduced through the first manifold inlet 351i and second manifold inlet 352i (flowing in the y-direction (e.g., into the page)), to the HX tube 300. The process pressure (P_{ads}) may be under atmospheric. Due to low pressure drops of the IMHX module 20, power consumption to circulate carrier gas at high gas space velocity may be minimized.

FIG. 16B is a view of the IMHX module 20 for regeneration at lower pressure and/or higher temperature, according to one or more embodiments. As illustrated in FIG. 16B, after the adsorbent is saturated, the process fluid Fp may be stopped and a hot thermal fluid Ft may be introduced through the first manifold inlet 351i and second manifold inlet 352i (flowing in the y-direction (e.g., into the page)), to the HX tube 300. The pressure in the vessel 900 may be maintained at a desorption pressure (P_{des}). The hot thermal fluid Ft may heat up the adsorbent to desorption temperature (T_{des}) and desorbed alcohols may be pulled as alcohol vapor out of the vessel 900 by a vacuum pump 1600. Regeneration may be quickly completed by both heating and pulling vacuum. By operating adsorption at high space velocity, a small adsorption vessel may be used for the vessel 900.

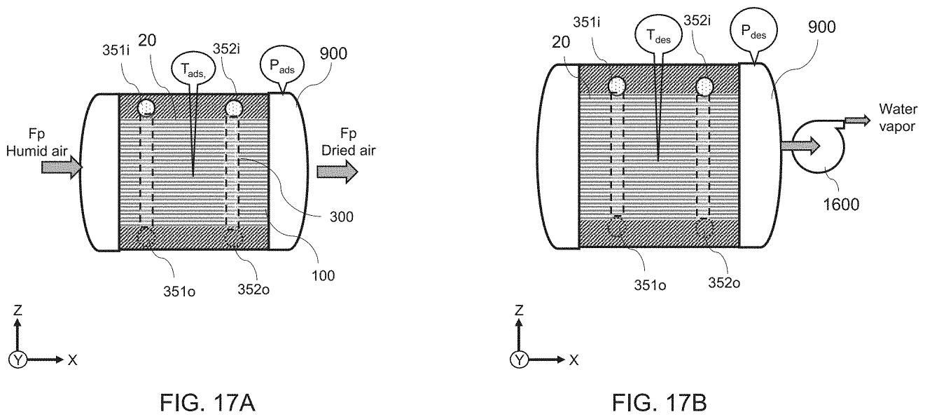

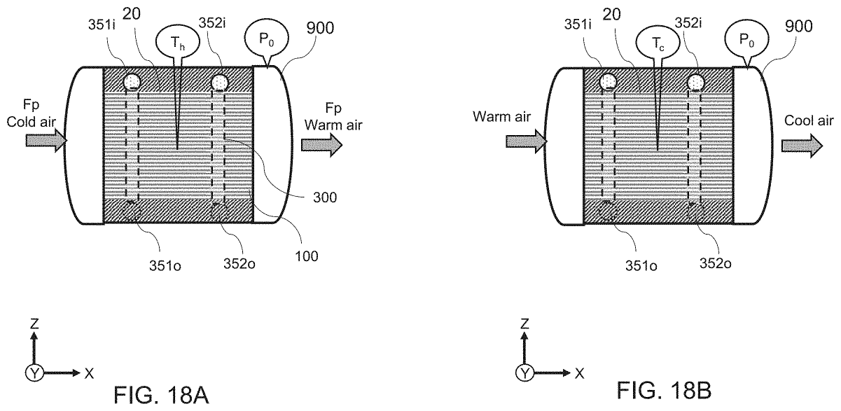

FIGS. 17A-18B illustrate an application of IMHX module 20 loaded with H₂O-selective adsorbent material (e.g., as functional material 102 in the MHX plate 100) to air dehumidification, according to one or more embodiments. In particular, FIG. 17A is a view of the IMHX module 20 for performing adsorption at process pressure (P_{ads}) and temperature (T_{ads}) in the vessel 900, according to one or more embodiments. In at least one embodiment, the adsorption temperature (T_{ads}) may be less than 60° C. As illustrated in FIG. 17A, humid air Fp may enter the vessel 900 and flow in the x-direction through the process channel in the IMHX module 20. Water vapor may be captured by the adsorbent (e.g., functional material 102) in the MHX plate 100. In instances in which the moisture content is high, heat of adsorption may be removed by introducing cold thermal fluid Ft to keep the adsorbent and dried air temperature within a targeted range. The cold thermal fluid Ft may be introduced through the first manifold inlet 351i and second manifold inlet 352i (flowing in the y-direction (e.g., into the page)), to the HX tube 300. The straight mini-channels may enable low air pressure drops.

Once the adsorbent is saturated, the vessel may be switched to regeneration. FIG. 17B is a view of the IMHX module 20 for regeneration at lower pressure (P_{des}) and/or higher temperature (T_{des}), according to one or more embodiments. As illustrated in FIG. 17B, a hot thermal fluid Ft may be introduced through the first manifold inlet 351i and second manifold inlet 352i (flowing in the y-direction (e.g., into the page)), to the HX tube 300. The hot thermal fluid Ft may be introduced to heat up the adsorbent to desorption temperature (T_{des}) and desorbed water vapor may be pulled out of the module by the vacuum pump 1600.

Rapid heating and cooling with the IMHX module 20 may shorten the vessel turn-around time so that a compact vessel may be used (e.g., as the vessel 900) for dehumidifying air of large volume flow rates. Compared to days of regeneration turn-around time with current desiccant bed/vessel, the turn-around time in tens of minutes to hours may be realized with the IMHX module 20.

FIGS. 18A-18B illustrate an application of IMHX module 20 loaded with thermal storage material to air heating and cooling, according to one or more embodiments. The phase change material (PCM) such as waxes may be loaded in the MHX plate 100 (e.g., MHX matrix) as the functional material 102. The PCM may be encapsulated with an encapsulation medium 103 such as a dense metal sheet. The PCM may release heat when the PCM changes from liquid to solid phase (solidification) and may take up the heat when the PCM changes from solid phase to liquid phase (melting). Different from a conventional air/thermal fluid exchangers, the IMHX module 20 having a thermal energy storage capacity as in FIGS. 18A-18B may help maintaining air temperature without resorting extra heating or cooling duty when air temperature changes over a wide range.

In particular, FIG. 18A is a view of the IMHX module 20 for performing air heating at solidification temperature (Tₕ) in the vessel 900, according to one or more embodiments. As illustrated in FIG. 18A, cold air Fp at temperatures below the PCM solidification temperature may enter vessel 900 and flows in the x-direction through the process channel in the IMHX module 20. The cold air Fp may be heated up through heat exchange with the MHX plate 100. Heat may be provided by solidification of PCM in the MHX plate 100. The pressure in the vessel 900 may be maintained at a pressure (P₀) (e.g., predetermined pressure). When all the PCM is solidified, i.e., thermal storage capacity is used up, a hot thermal fluid Ft can be introduced into the heat exchange tube 300 to melt the PCM. Thus, air heating may be performed with or without concomitant introduction of hot thermal fluid Ft. The hot thermal fluid Ft may be introduced through the first manifold inlet 351i and second manifold inlet 352i (flowing in the y-direction (e.g., into the page)), to the HX tube 300.

FIG. 18B is a view of the IMHX module 20 for air cooling, according to one or more embodiments. As illustrated in FIG. 18B, the IMHX module 20 loaded with thermal storage material (e.g., as functional material 102) may also be used for air cooling. Warm air with temperatures above melting point of the PCM (Tc) may enter vessel 900 and flows through the IMHX module 20. Air may be cooled by transporting its heat to the MHX plate 100 and the heat may be taken up by melting of the PCM. When all the PCM solid is melted and cooling capacity is used up, a cold thermal fluid Ft can be introduced into the heat exchange tube 300 to solidify the melted PCM. The cold thermal fluid Ft may be introduced through the first manifold inlet 351i and second manifold inlet 352i (flowing in the y-direction (e.g., into the page)), to the HX tube 300.

Thus, air cooling may be conducted with or without concomitant introduction of cold thermal fluid Ft. The pressure in the vessel 900 may be maintained at a pressure (P₀) (e.g., predetermined pressure). For building air conditioning, it may be desirable to provide small air pressure drops to minimize air fan power consumption. It may also be desirable to provide compact thermal storage plus air heat exchange equipment. The embodiment IMHX module 20 in FIGS. 18A and 18B may provide these performance features.

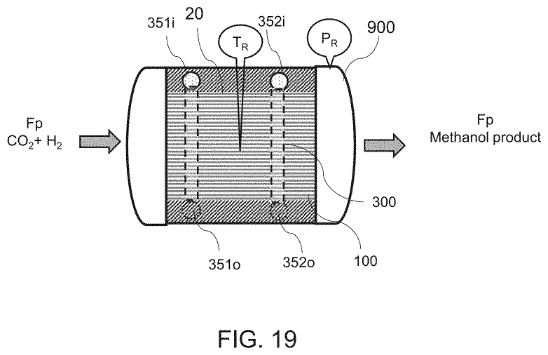

FIG. 19 illustrates an application of IMHX module 20 loaded with a catalytic material (e.g., as functional material 102 in the MHX plate 100) to provide the hydrogenation of CO₂ into methanol, according to one or more embodiments. The catalyst powder may be loaded in the MHX plate 100 (e.g., MHX matrix) and encapsulated with an encapsulation medium 103 that may include, for example, a micro-porous, thin metal membrane sheet. In this type of application, pressure drop for the process flow may not be a major factor. However, it may be desirable to optimize heat transfer and catalyst loading to affect the reactor throughput and product selectivity. Thus, the process channel spacing (e.g., L_{MXC}) may be designed at 0.5 mm, the MHX plate thickness may be designed in a range from 0.5 mm-5.0 mm (e.g., about 3 mm) with volume loading fraction of the catalytic material in a range from 0.2 to 0.8 (e.g., about 0.5). The IMHX module 20 may be placed inside the vessel 900 (e.g., pressure vessel) made of steel.

A process fluid Fp (e.g., process flow) including CO₂ and H₂ gas may enter the vessel 900 that is controlled to have pressure PR (e.g., about 20 bar). As the process gas Fp flows through the IHMX module 20, CO₂ and H₂ may diffuse into the MHX plate 100 and react into methanol at the catalytic site (e.g., the functional material 102). The methanol may diffuse out of the MHX plate 100 into the process stream and exit the vessel 900 as (e.g., methanol-containing reacted product stream). Concomitantly, thermal fluid T_{f} may be introduced into the heat exchange tube 300 and remove heat produced from the reaction to maintain the HMX plate temperature at the target level (about 230° C.) by rapid heat transfer between the heat exchange tube 300 and catalytic materials (e.g., as functional material 102). The thermal fluid Ft may be introduced through the first manifold inlet 351i and second manifold inlet 352i (flowing in the y-direction (e.g., into the page)), to the HX tube 300.

Formation of localized “hot” spots on the MHX plate 100 may, therefore, be substantially eliminated. The reaction and heat exchange may be conducted under steady-state operating conditions.

### Example I. Assembly of MHX plate 100 and IMHX module 20

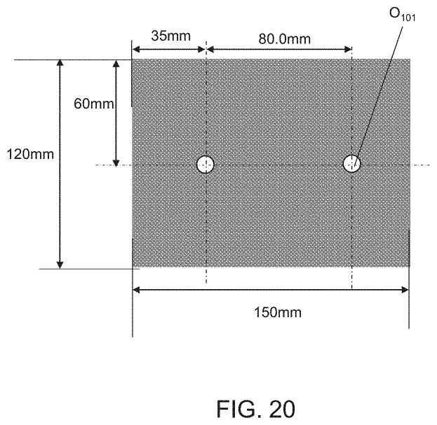

FIG. 20 is a plan view of a supporting matrix 101, according to one or more embodiments. As illustrated in FIG. 20, the supporting matrix 101 may include a perforated aluminum sheet of 1.6 mm thickness having openings O₁₀₁ (e.g., rounded holes). The perforated aluminum sheet may have an open area fraction of 0.4 and is cut into 120 mm depth×150 mm width. The rounded holes with 3.2 mm diameter may be uniformly patterned on the sheet. As shown in FIG. 20, two rounded opens may be drilled on the sheet for insertion of heat exchange tubes with outer diameter of 12.5 mm and wall thickness of 1.2 mm. The heat exchange tubes are positioned in centerline of the sheet with center-to-center spacing of 80 mm.

Silica gel powder may be used as a functional material for adsorption of moisture from humid air. The powder may have specific surface area of 500 m²/g, pore volume of 0.75 cc/g, and average particle size of 55 μm. First, an aluminum wire cloth sheet of 200×200 Mesh Size is used as an encapsulation medium. The wire diameter, opening and open area fraction are 53 μm, 73 μm, and 0.34, respectively. The mesh sheet thickness is equivalent to single wire diameter, i.e., 53 μm. The mesh sheet is cut into 120 mm×150 mm and attached to bottom surface of the perforated aluminum plate by use of Viton adhesive. The supporting bottom encapsulated by the mesh is placed on a bench surface. The silica gel powder is spread on the top surface of the plate and leveled to fill all the holes on the supporting plate. After the supporting plate is lifted up, significant amounts of the powder are left on the bench surface. As expected, the mesh pore size (73 μm) is too large to hold all the silica powder of average particle size of 53 μm.

Second, a PTFE membrane film of 5 μm thickness and 0.3 μm pore size is used as an encapsulation medium. The membrane film has air permeance of 1.3×10⁻² mol/(m²·s·Pa). The membrane film is so thin that it looks almost transparent. The membrane film is cut to 120 mm×150 mm and attached to the bottom of the supporting plate by use of Viton adhesive. The membrane-encapsulated supporting plate is placed on a work bench with open holes facing up. The silica gel is spread on the surface of the supporting plate and leveled to fill all the holes. 4.6 g of the powder is loaded. After the plate is lifted off the bench, no powder is left on the bench and small membrane pores block all the powder as expected. The 5 μm-thin PTFE membrane film is mechanically week and can be damaged by incidental scratching and piercing.

Third, the aluminum mesh sheet may be laminated with the PTFE membrane film as an encapsulation medium. The PTFE-laminated mesh sheet is used to encapsulate bottom of the supporting plate by use of the adhesive. The silica powder may be used to fill the holes of the supporting plate. About 5.2 g of the powder may be loaded and no leakage of the powder through the encapsulation medium is observed. The PTFE-laminated Al mesh sheet provides mechanical strength and small pore size with thickness of only about 3.5% of the supporting plate thickness and thus, may be used to build the IMHX module.

Forty of the above described supporting plates in FIG. 20 may be made. The supporting bottom may be first encapsulated with the PTFE-laminated Al mesh. Then, the holes in the supporting plate may be fully packed with the silica gel powder and the top surface may be encapsulated with the PTFE-laminated Al Mesh to form a MHX plate 100. Forty of the MHX plates including the cover plates may be stacked into the IMHX module with use of a few other parts.

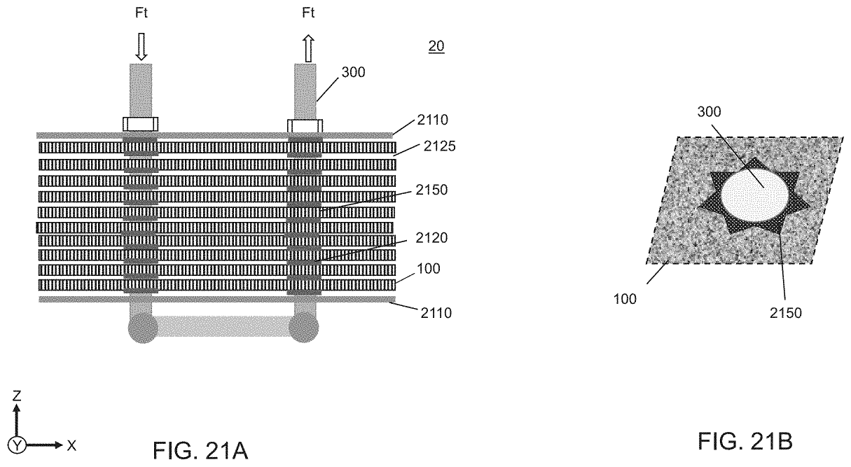

FIG. 21A is a vertical cross-sectional view of an IMHX module 20 including the forty MHX plates 100, according to one or more embodiments. A U-shaped aluminum tube with 12.5 mm outer diameter is used as the heat exchange tube 300. Two cover plates 2110 made of dense aluminum sheet with 3 mm thickness may be used to sandwich stack of the MHX plates. Two aluminum spacers 2120 of 13 mm width×120 mm depth×1.6 mm thickness are placed in parallel to the process flow direction between the two MHX plates to form process flow channel 2125 of 1.6 mm spacing. In operation, process fluid Fp may flow in the y-direction (into the page) in the process flow channel 2125. The spacer 2120 has an opening in the middle for the heat exchange tube to go through. Thus, the spacer 2120 helps thermal conduction from the heat exchange tube 300 to depth of the MHX plate 100. Air gaps in the IMHX module 20 (e.g., assembly) should be eliminated or minimized to achieve high heat transfer rate.

FIG. 21B illustrates top-down view of the heat exchange tube/MHX plate interfacing region, according to one or more embodiments. The gap between the MHX plate 100 and the heat exchange tube 300 may be fully filled with a heat transfer filler 2150 such as boron nitride thermal paste. The paste has thermal conductivity of 31 W/(m·K). The air gaps between the spacer 2120 and MHX plate 100 may be eliminated by compressing the stack with the cover plates 2110.

The resulting IMHX module 20 may have heat exchanging diameter of about 12.5 mm (interface with the MHX plate 100), inner diameter of 10.1 mm for thermal fluid Ft, one 1.6 mm height×67 mm wide and two 1.6 mm height×28.5 mm wide channels for process flow, adsorbent volume loading fraction in the MHX plate 100 of 0.37, and ratio of the encapsulation medium thickness to the overall MHX plate thickness of 0.035. The IMHX module 20 may allow atmospheric air to flow through at space velocity of 50,000 v/v 1/h with pressure drop less than 100 Pa.

### Example II. Direct capture of CO₂ from air

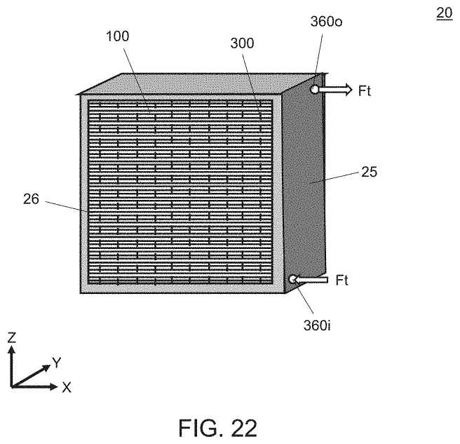

FIG. 22 is a schematic view of an IMHX module 20, according to one or more embodiments. The IMHX module 20 may include four hundred (400) MHX plates 100 stacked together. The IMHX module 20 may be used, for example, for direct air capturing (DAC) of CO₂ from air. The design parameters of the MHX plate 100 for DAC may be listed in Table 5.

A perforated aluminum plate may be used as the supporting matrix 101 with sizes of 0.24 m depth×1.1 m width×0.002 m thickness. The MHX plate 100 may have a 0.02 m-wide solid edge to maintain its mechanical strength, while the rest has 80% porosity. The void may include ordered holes of 0.003 m-diameter holes that may be filled with solid adsorbent powder of particle sizes less than 50 μm. The adsorbent may be made by deposition of a solid base on meso-porous silica with BET surface area greater than 200 m²/g. CO₂ in air may be selectively captured on the adsorbent by its reaction or chemisorption with the basic site. The adsorbent powder may be further encapsulated by adhering a 60 μm-thin PTFE membrane-laminated aluminum mesh sheet on the two surfaces of the MHX plate 100. The porous encapsulating medium 103 may be substantially free of pores greater than 5 μm or fraction of the pores greater than 5 μm may be less than 2% of the overall surface to assure that the adsorbent powder may be fully retained inside the MHX plate 100. The porous encapsulating medium 103 may have gas permeance greater than 1×10⁻³ mol/(m²·s·Pa).

Two rows (e.g., arrays) of heat exchange (HX) tubes 300 with 0.006 m diameter may be disposed on the MHX plate 100 symmetrically with center-to-center spacing of 0.1 m. The interface between the HX tube 300 and the supporting matrix 101 may be sealed with thermal-conducting material to minimize thermal conduction resistance at the interface. Each row may have eleven (11) of the HX tubes 300. In total, there may be 22 tubes.

TABLE 5
Design parameters of MH plate for adsorption process
with small pressure drops at large air flow rates

| Supporting matrix | |
|---|---|
| Material | Aluminum |
| Shape | plate |
| Edge width, m | 0.02 |
| Total width, m | 1.100 |
| Total length, m | 0.240 |
| Thickness, m | 2.0E−03 |
| Porosity in active zone | 8.0E−01 |
| Working area, m² | 2.1E−01 |
| Working area/total | 8.0E−01 |
| Adsorption/working area | 9.4E−01 |
| Fraction of adsorption/total plate | 6.0E−01 |
| Weight, Kg | 0.565 |
| Adsorbent loading | |
| Material | Silica gel-supported solid base |
| Void diameter, m | 3.0E−03 |
| Adsorbent volume, liter | 3.2E−01 |
| Adsorbent, kg | 0.239 |
| Encapsulating medium | |
| Material | Micro-porous PTFE membrane- |
| | laminated thin aluminum mesh |
| | sheet of 200 × 200 mesh |
| Thickness, m | 6.0E−05 |
| Volume, liter/sheet | 0.0199 |
| Weight, Kg | 0.03 |
| Process channel spacer | |
| Material | Aluminum |
| Size | 0.001 m thickness × 0.01 m |
| | width × 0.24 m length |
| Heat exchange (HX) tube arrangement | |
| Diameter of HX tube, m | 6.0E−03 |
| Spacing for HX tube, m | 1.0E−01 |
| No of tube along depth | 2 |
| No of tube along width | 11 |
| Total No of tube | 22 |

The design parameters for the IMHX module 20 may be listed below in Table 6. The IMHX module 20 may include channels 26 (e.g., process fluid channels) between the MHX plates 100 and process fluid Fp (e.g., gas (air)) may flow into the channels 26. The process fluid Fp may flow in the y-direction (into the page) in the channel 26. In particular, there may be 11 gas (air) flow channels 200 of 1 mm height×9.4 mm width. The overall stacking height may be 1.24 m with 128 m² of working area for heat and mass transfer between air and the MHX plate 100.

The IMHX module 20 may further include a thermal fluid inlet 360i through which thermal fluid Ft may enter the HX tubes 300 and a thermal fluid outlet 360o through which thermal fluid Ft may exit the IMHX module 20. The IMHX module 20 may further include a thermal fluid connector 25 connecting the thermal fluid inlet 360i and thermal fluid outlet 360o. The HX tubes 300 for thermal fluid inlets and outlets may be bundled together via manifolds to have one common inlet and outlet. The manifolds may be sized and arranged in a way to provide uniform flow distribution into individual HX tubes 300. A solid frame may be used to maintain mechanical strength of the stacking. The overall module unit weight may be 391 kg with the adsorbent loading of 96 kg.

TABLE 6
Dimensions and weight of an IMHX module unit assembled from
the MHX plate of the design parameters listed in Table 5

| Gas flow channel | |
|---|---|
| Channel height, m | 1.0E−03 |
| channel width, m | 9.4E−02 |
| No of channel/layer | 1.1E+01 |
| Module sizing | |
| No of MHX plates | 400 |
| Height, m | 1.241 |
| Adsorption working area, m² | 128 |
| Cross-sectional area for gas flow, m² | 0.400 |
| Module volume, liter | 328 |
| Adsorbent vol, liter | 127.5 |
| Gas channel volume, liter | 96.0 |
| Weight breakdown | |
| Supporting matrix plate, kg | 225.9 |
| Adsorbent weight, kg | 95.7 |
| Membrane sheet, kg | 35.5 |
| HX tube, kg | 2.0 |
| Thermal fluid, kg | 1.5 |
| Frame, kg | 30 |
| Total, kg | 391 |

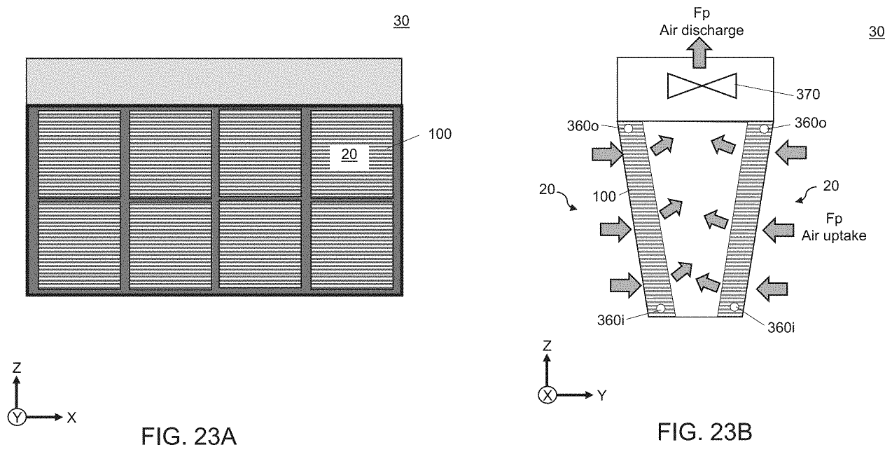

FIGS. 23A and 23B illustrate an IMHX modular cart 30, according to one or more embodiments. For large scale DAC applications, individual IMHX modules 20 may be further grouped together as the IMHX modular cart 30, which can be prefabricated and shipped to the user site. In particular, FIG. 23A is an air entrance view of the modular cart 30 including the group of IMHX modules 20, according to one or more embodiments. The modular cart 30 may include a plurality of the above IMHX modules 20. As illustrated in FIG. 23A, eight (8) IMHX modules 20 may be configured together to form a wall. Process fluid Fp (e.g., air uptake) may flow through the process flow channels between the MHX plates 100 in the y-direction (into the page) in FIGS. 23A-23B.

FIG. 23B is a vertical cross-sectional view of the modular cart including air flow paths, according to one or more embodiments. As illustrated in FIG. 23B, two of the walls in FIG. 23A may be installed to form the modular cart 30 with one or more common air fans 370 on the top. Thus, the modular cart 30 in FIGS. 23A-23B may include 16 IMHX modules 20 (i.e., 2 walls×8 IMHX modules per wall). The thermal fluid Ft may enter each of the IMHX modules 20 through the thermal fluid inlet 360i and exit through the thermal fluid outlet 360o.

Air (process fluid Fp) may be suctioned into the process flow channels (e.g., adsorption channels) from two sides and discharged from the top as air discharge Fp. The total air flow rate may be about 1,900 mol/s (90,000 scfm), which corresponds to air velocity inside the adsorption channel of 7 m/s. The air pressure drop through the adsorption channel may be about 240 Pa with fan power consumption about 32 kW. At average 50% of CO₂ capture, the CO₂ capturing rate of such a modular cart may be about 60 kg/h. The modular cart dimensions may be about 3 m height×2.5 m wide×4.5 mm width, and weighs about 6.5 ton. Such a modular cart 30 can be transported by regular trucks.

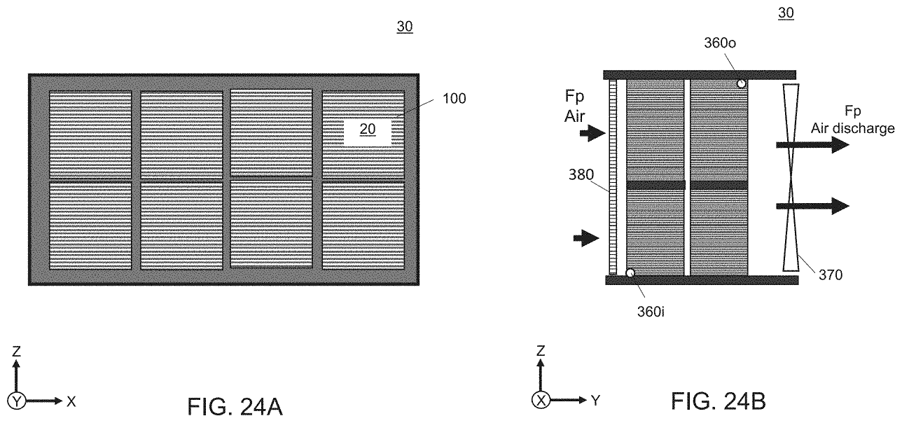

FIGS. 24A and 24B are views of the IMHX modular cart 30 having an alternative design, according to one or more embodiments. The IMHX modular cart 30 illustrated FIGS. 23A and 23B may be compact but may impose high pressure drops. The IMHX modular cart having the alternative design in FIGS. 24A and 24B may help to alleviate the high pressure drops.

FIG. 24A is an air flow front view of the IMHX modular cart 30 having the alternative design, according to one or more embodiments. FIG. 24B is an air flow side view of the IMHX modular cart 30 having the alternative design, according to one or more embodiments.

As illustrated in FIG. 24A, eight (8) identical IMHX modules 20 may be grouped together. Then as illustrated in FIG. 24B, two of the groups may be placed inside the IMHX modular cart 30 in parallel. A mesh screen 380 may then be installed on the left side to prevent large debris, birds, and insects from getting into the process flow channel (e.g., air channel) between the MHX plates 100. One or a few air fans 370 may be installed on the right side to pull atmospheric air through the process flow channels. In this configuration, air flows in one direction and at constant velocity so that air fan power consumption can be reduced relative to the configuration shown in FIG. 23B where from intake to discharge, air flow changes its flow direction and increases its velocity. However, the FIG. 24B configuration may require a larger space to generate uniform air flow distribution.

Pressure and vacuum vessels are commonly used in today's industrial scale adsorption processes. Adsorption and regeneration can be performed in the same vessel by switching process flows and changing the vessel operating conditions. Due to low CO₂ concentration in air and huge air volume flow rate in DAC process, however, stationary adsorption vessel designs may become too expensive and may also result in high air fan power consumption. A large-scale CO₂ production plant can be built by use of many of the identical IMHX modular carts 30 moving between regeneration and capture stations.

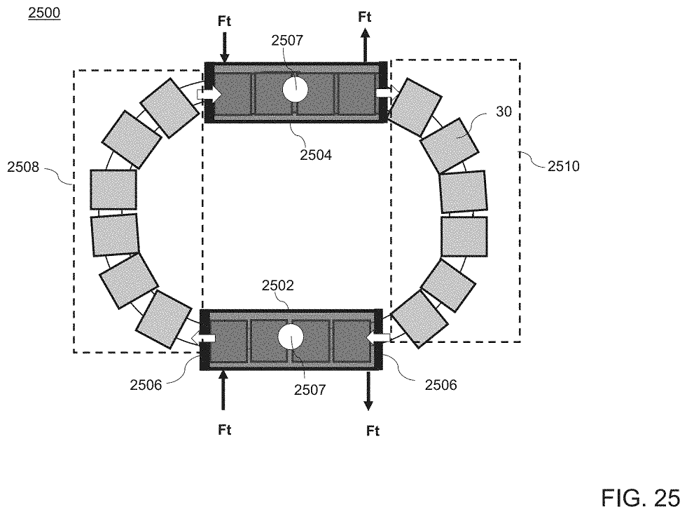

FIG. 25 is a schematic diagram of a CO₂ capturing plant 2500 with rotating IMHX modular carts 30, according to one or more embodiments. The layout for the CO₂ capturing plant 2500 (e.g., production plant) may include about 48 IMHX modular carts 30 under capture and about 24 IMHX modular carts 30 under regeneration for a total of 72 IMHX modular carts 30 and a total production of CO₂ of about 88 ton/day. Note that the number of IMHX modular carts 30 shown in the FIG. 25 is only for illustration purposes and does not necessarily reflect an actual number of carts under operation.

The IMHX modular carts 30 may form a close loop with equivalent circle of diameter about 110 m. The IMHX modular carts 30 may move around the loop in a clockwise direction as indicated by the directional arrows. In this way, all the IMHX modular carts 30 can be moved at the same time. The CO₂ capturing plant 2500 may further include a first regeneration chamber 2502 and a second regeneration chamber 2504. The first regeneration chamber 2502 and second regeneration chamber 2504 may be located on opposite sides of the loop. The first regeneration chamber 2502 and second regeneration chamber 2504 may be built on the loop to host 12 carts in each of the first regeneration chamber 2502 and second regeneration chamber 2504. The first regeneration chamber 2502 and second regeneration chamber 2504 may include vacuum doors 2506. The vacuum doors 2506 may be located on the entrance side and exit side of the first regeneration chamber 2502 and second regeneration chamber 2504 and may be shut to form an air tight seal. The first regeneration chamber 2502 and second regeneration chamber 2504 may also include a regeneration offgas port 2507 that may exhaust offgas from the regeneration process. Thermal fluid Ft (e.g., hot thermal fluid) may enter each of the first regeneration chamber 2502 and second regeneration chamber 2504 to raise a temperature of the MHX plates 100 in the IMHX modular carts 30 to a desorption temperature. The first regeneration chamber 2502 and second regeneration chamber 2504 may each enable control of regeneration conditions, such as temperature, pressure, and purge flow.

The CO₂ capturing plant 2500 may also include a first capture section 2508 and a second capture section 2510 on opposite sides of the loop. The IMHX modular carts 30 outside the first regeneration chamber 2502 and second regeneration chamber 2504 may located in the first capture sections 2508 and a second capture section 2510 where the IMHX modular carts 30 may be exposed to ambient air for CO₂ capture.

Once the regeneration is completed, 24 of modular carts 30 (12 in each regeneration chamber) may be rotated out of the regeneration chamber, while 24 saturated module carts 30 may be moved in at the same time. The CO₂ capture and regeneration process conditions may be listed in Table 7. Rapid regeneration may have a direct impact on the utilization efficiency of the modular cart 30 and capital cost. The design of the IMHX module 20 may enable quick regeneration by rapid heating/cooling and pulling vacuum. The capture and regeneration time for an IMHX module cart 30 may be designed as 60 and 30 min, respectively.

TABLE 7
Process conditions for operation of a DAC plant

| CO₂ capture conditions | | Regeneration conditions | |
|---|---|---|---|
| Operating and design | Atmospheric | Heating and | 20 |
| pressure | air | desorption time, | |
| | | min | |
| Operating temperature | Ambient air | Setup and cooling | 10 |
| | | time, min | |
| Design temperature, | 20 | Total regeneration | 30 |
| ° C. | | time, min | |
| Design air velocity | 7 | Pressure at start | Atmospheric |
| in adsorption channel, | | and end, kPa | |
| m/s | | | |
| Capturing time, min | 60 | Pressure during | 10 |
| | | desorption, kPa | |
| Avg CO₂ capture, % | 50 | Temperature during | 80 |
| | | desorption, ° C. | |
| | | CO₂ produced | 5,500 |
| | | during heating, | |
| | | Kg/h | |
| | | Normalized daily | 88,000 |
| | | rate, Kg/day | |

In the modular cart loop illustrated in FIG. 25, each IMHX modular cart 30 may have built-in air fans. This will increase the cart size and regeneration chamber size.

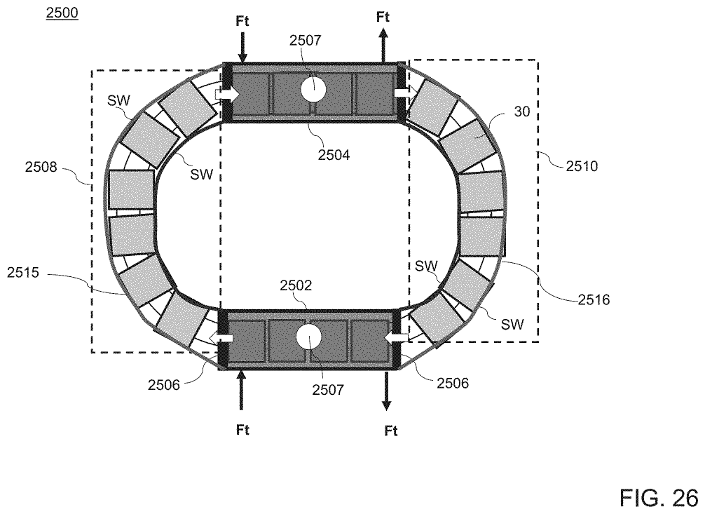

FIG. 26 illustrates a CO₂ capturing plant 2500 having an alternative design, according to one or more embodiments. In the alternative design of FIG. 26, the CO₂ capturing plant 2500 may include a first tunnel enclosure 2515 (e.g., atmospheric air tunnel enclosure) on the first capture section 2508 and a second tunnel enclosure 2516 (e.g., atmospheric air tunnel enclosure) on the second capture section 2510. Each of the first tunnel enclosure 2515 and second tunnel enclosure 2516 may include a weather-proof tunnel including fixtures such as screens, air fans, safety barriers, etc. Air may enter one end and exit an opposite end in each of the first tunnel enclosure 2515 and second tunnel enclosure 2516.

Each of the first tunnel enclosure 2515 and second tunnel enclosure 2516 may protect the IMHX modular carts 30 located therein from weathering, such as rain fall, snow, etc. As the IMHX modular cart 30 travels inside the first tunnel enclosure 2515 and second tunnel enclosure 2516, atmospheric air may be blown into and/or drawn out of the process flow channels (e.g., air channels) in the IMHX modules 20 by air fans mounted on opposing side walls SW of the first tunnel enclosure 2515 and second tunnel enclosure 2516.

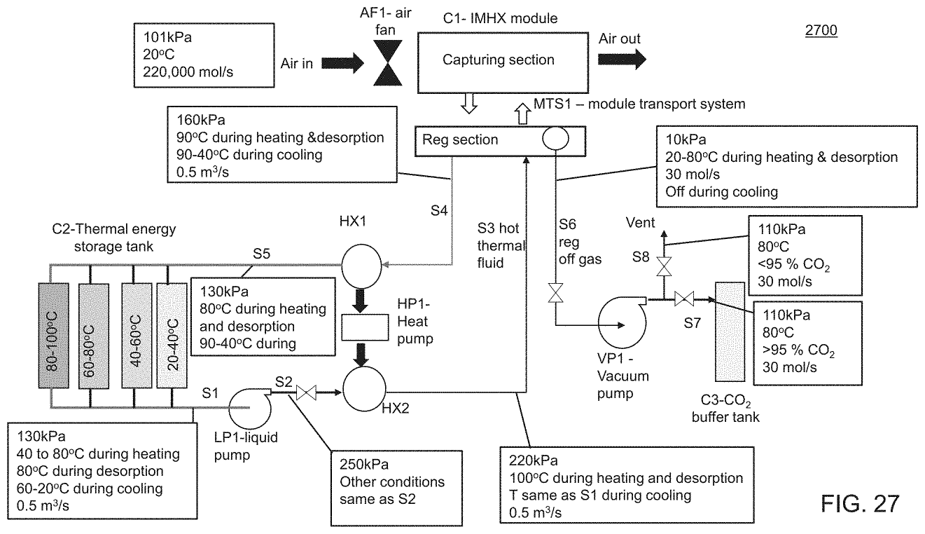

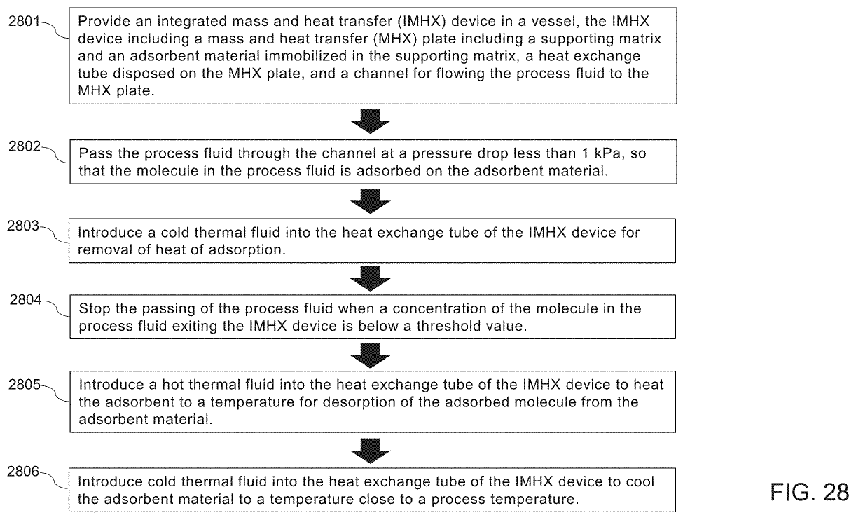

FIG. 27 is a process flow diagram of a direct air capturing (DAC) plant 2700 (e.g., CO₂ production plant) including the IMHX module 20, according to one or more embodiments. An example of an operating procedure for the DAC plant 2700 may be described as follows:
1) Air may be blown by an air fan (AF1) through adsorption channels in the adsorption section of the IMHX modular array (C1).
2) When the adsorbent is saturated, the vacuum door of the regeneration chamber may be opened, and the IMHX modular cart 30 may be moved into the chamber while the regenerated one may be moved out via a modular transport system (MTS1).
3) After the saturated MHX module 20 is set in the regeneration chamber, the vacuum door may be closed, residual air may be pumped out by vacuum pump (VP1) to ventilation.
4) Meanwhile, thermal fluid may be connected to the MHX module 20, pumped out of storage tank (C2) by a liquid pump (LP1), and heated to regeneration temperature by aid of a heat pump (HP1) (e.g., hot thermal fluid may be produced by using the heat pump).
5) The hot thermal fluid (stream 3) heats up the adsorbent.
6) When the regeneration temperature is reached, released CO₂ gas (>95%) may be pumped by VP1 to a storage tank C3.
7) During heating/desorption, the thermal fluid returned from the regeneration section (stream 4) may be cooled by the heat pump HP1 and returned to the storage tank C2.
8) When CO₂ is not released anymore, the regeneration may be completed. VP1 and HP1 may be stopped, and LP1 may be continued to cool down the IMHX module 20. The sensible heat may be recovered and stored in C2. Meanwhile, the regeneration chamber may be gradually pressurized by ambient air.
9) When the IMHX module 20 temperature is stabilized and the regeneration chamber may be back to atmospheric pressure, the vacuum doors may be opened and operation step 2 may be resumed.

It is noted that the thermal fluid storage tank C2 may include a group of vessels loaded with phase-change-material (PCM) for storage of thermal energy at different working temperatures. As listed in Table 6, the adsorbent may include only a fraction of the total weight of an IMHX module 20. Relative to heat of desorption, significant amounts of sensible heat may be required to heat up the module from ambient temperature to regeneration temperature (80° C.-100° C.). With the four C2 storage vessels in the DAC plant 2700 as an example, during heating up process, the thermal fluid may be withdrawn from the four storage vessels in a sequence of 20° C.→40° C.→60° C.→80° C. to fully utilize the stored thermal energy; when the desorption temperature is reached, the thermal fluid from the 80° C.-100° C. vessel may be circulated. After desorption is completed, the heat pump may be turned off, and the thermal fluid may be withdrawn from the storage vessel in a sequence of 80° C.→60° C.→40° C.→20° C. to fully recover sensible heat from the hot IMHX module 20.

Without thermal energy storage, sensible heat may be recovered by configuring a series of heat exchangers, which may increase process complexity and cost.

Design and operation conditions of the equipment in the DAC plant 2700 may be listed in Table 8 for the storage vessels, Table 9 for the fluid pumping equipment (pumps), and Table 10 for the heat exchangers. The DAC plant 2700 using the IMHX module 20 may enable economic CO₂ production from air. The modular unit provides flexibility to meet different scales of production capacity by adjusting the number of IMHX modules 20 used. Because regeneration needs rough vacuum only, water-based educators may be used to generate vacuum. Water separated from CO₂ gas in a gas/liquid separator can be recycled and no net water consumption occurs in the process. As a result, water and air could be primary working fluids in the DAC plant with no environmental emissions and with low safety risks.

TABLE 8
Vessels used in an exemplary DAC plant

| C2 - thermal fluid storage tank | |
|---|---|
| Work fluid | ethylene glycol/water |
| | (as coolant in cars) |
| Design temperature, ° C. | 120 |
| Design pressure, kPa | 250 |
| Volume, m³ | 200 |
| Total thermal energy storage capacity, | 100,000 |
| kW *h | |
| No of vessel | 4 |
| Vessel diameter, m | 3 |
| Vessel height, m | 8 |
| C3 - CO₂ buffer tank and G/L separator | |
| Work fluid | CO₂ gas, moisture, water |
| Design temperature, ° C. | Up to 80 |
| Design pressure, kPa | 110 |
| Volume, m³ | 70 |
| No of vessel | 1 |
| Vessel diameter, m | 3 |
| Vessel height, m | 10 |

TABLE 9
Major pieces of equipment used in an exemplary DAC plant

| AF1- air fan | |
|---|---|
| Work fluid | Air under all weather conditions |
| Design conditions | 30 |
| Flow rate, mol/s (scfm) | 1,900 (90,000) |
| Pressure boost, Pa | 250 |
| Temperature, ° C. | 20 |
| Efficiency, % | 70 |
| Power, Kw | 16 |
| No of air fan | 48 |
| Total power, Kw | 766 |
| LP1- liquid pump for thermal fluid | |
| Work fluid | ethylene glycol/water |
| | (as coolant in cars) |
| Design temperature, ° C. | 80 |
| Suction pressure, kPa | 130 |
| Discharge pressure, kPa | 250 |
| Flow rate, m³/s | 0.5.0 |
| No of pump | 2 |
| Pump power, kW/each | 45 |
| VP1- Vacuum pump | |
| Work fluid | Air, CO₂, moisture CO₂ |
| Design temperature, ° C. | 80 |
| Suction pressure, kPa | 10 |
| Discharge pressure, kPa | 110 |
| Flow rate, mol/s | 30 |
| No of pump | 2 |
| Pump power, kW/each | 250 |

TABLE 10

| HP1- heat pump | |
|---|---|
| Low-T source | |
| High-T temperature increase, ° C. | 120 |
| Thermal duty, kw | 10,000 |
| COP | 4 |
| Electrical power, kW | 2,500 |
| HX 1 - Evaporator | |
| Work fluid | ethylene glycol/water |
| | (as coolant in cars) |
| Design temperature, ° C. | 80 |
| pressure, kPa | 250 |
| Flow rate, m³/s | 0.5 |
| Refrigerator vapor | |
| Fluid | To be determined by the heat pump |
| Heat exchanging duty, kW | 10,000 |
| Temperature gradient, ° C. | 10 |
| HX2 - Condenser | |
| Work fluid | ethylene glycol/water |
| | (as coolant in cars) |
| Design temperature, ° C. | 80 |
| pressure, kPa | 250 |
| Flow rate, m³/s | 0.5 |
| Refrigerator vapor | |
| Fluid | To be determined by the heat pump |
| Heat exchanging duty, kW | 10,000 |
| Temperature gradient, ° C. | 10 |

FIG. 28 is a flowchart illustrating a method for capturing a molecule from a process fluid, according to one or more embodiments. Step 2801 may include providing an integrated mass and heat transfer (IMHX) device in a vessel, the IMHX device including a mass and heat transfer (MHX) plate including a supporting matrix and an adsorbent material immobilized in the supporting matrix, a heat exchange tube 300 disposed on the MHX plate 100, and a channel 102 for flowing the process fluid to the MHX plate 100. Step 2802 may include passing the process fluid through the channel 200 at a pressure drop less than 1 kPa, so that the molecule in the process fluid is adsorbed on the adsorbent material. Step 2803 may include introducing a cold thermal fluid into the heat exchange tube 300 of the IMHX device for removal of heat of adsorption. Step 2804 may include stopping the passing of the process fluid when a concentration of the molecule in the process fluid exiting the IMHX device is below a threshold value. Step 2805 may include introducing a hot thermal fluid into the heat exchange tube of the IMHX device to heat the adsorbent to a temperature for desorption of the adsorbed molecule from the adsorbent material. Step 2806 may include introducing cold thermal fluid into the heat exchange tube of the IMHX device to cool the adsorbent material to a temperature close to a process temperature.

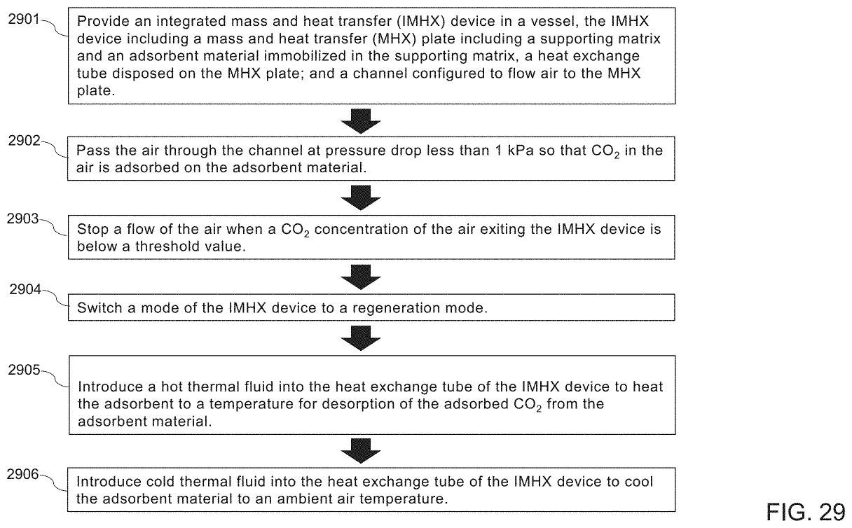

FIG. 29 is a flowchart illustrating a method for capturing CO₂ from air, according to one or more embodiments. Step 2901 may include providing an integrated mass and heat transfer (IMHX) device in a vessel 900, the IMHX device including a mass and heat transfer (MHX) plate 100 including a supporting matrix 101 and an adsorbent material immobilized in the supporting matrix 101, a heat exchange tube 300 disposed on the MHX plate 100; and a channel 200 configured to flow air to the MHX plate. Step 2902 may include passing the air through the channel 200 at pressure drop less than 1 kPa so that CO₂ in the air is adsorbed on the adsorbent material. Step 2903 may include stopping a flow of the air when a CO₂ concentration of the air exiting the IMHX device is below a threshold value. Step 2904 may include switching a mode of the IMHX device to a regeneration mode. Step 2905 may include introducing a hot thermal fluid into the heat exchange tube of the IMHX device to heat the adsorbent to a temperature for desorption of the adsorbed CO₂ from the adsorbent material. Step 2906 may include introducing cold thermal fluid into the heat exchange tube 300 of the IMHX device to cool the adsorbent material to an ambient air temperature.

Referring to all drawings and according to various embodiments of the present disclosure, a device for mass and heat transfer is provided, which may include: a device for mass and heat transfer 10, 20, 30, 900, 2500, including: a mass and heat transfer (MHX) plate 100 having a thickness in a range from 0.5 mm to 5 mm and including: a supporting matrix 101 that is thermally conductive; and a functional material 102 in the supporting matrix 101, wherein a volume fraction of the functional material 102 in the MHX plate 100 is in a range from 0.2 to 0.8; and a heat exchange tube 300 configured to transport a thermal fluid Ft and disposed on the MHX plate 100 such that heat is transferred between the thermal fluid Ft and the MHX plate 100, wherein a surface of the MHX plate 100 comprises a process flow channel 200 of hydraulic diameter in a range from 0.3 mm to 3 mm and a process fluid Fp in the process flow channel 200 exchanges heat with the MHX plate 100.

In one embodiment, the MHX plate 100 may include a plurality of MHX plates 100 stacked in parallel, the heat exchange tube 300 may include a plurality of heat exchange tubes 300 at a spacing in a range from 5 mm to 200 mm and the process flow channel 200 may be located between the plurality of heat exchange tubes 300 and the plurality of MHX plates 100. In one embodiment, the device for mass and heat transfer may further include: a thermal conducting spacer between the plurality of MHX plates 100 to enforce mechanical integrity of the plurality of MHX plates 100 and enhance heat transfer between the plurality of heat exchange tubes 300 and the plurality of MHX plates 100. In one embodiment, the supporting matrix 101 may include one of aluminum or copper and has a thermal conductivity greater than 50 W/(m·K). In one embodiment, the heat exchange tube 300 may have a hydraulic diameter in a range from 1 mm to 30 mm and may have a thermal flow direction perpendicular to a surface of the MHX plate 100. In one embodiment, the heat exchange tube 300 may have a hydraulic diameter in a range from 1 mm to 5 mm and has a thermal flow direction parallel to a surface of the MHX plate 100. In one embodiment, the functional material 102 may include one of a powder or particle having a particle size less than 0.1 mm. In one embodiment, the supporting matrix 101 may include a plurality of voids having a hydraulic diameter in a range from 0.5 mm to 6.0 mm and the functional material 102 is in the plurality of voids. In one embodiment, the process fluid in the process flow channel 200 exchanges mass with the MHX plate 100 and the functional material 102 may include a solid sorbent for selective adsorption of a molecule in the process fluid. In one embodiment, the functional material 102 may include a catalyst to catalyze a reaction of a molecule in the process fluid. In one embodiment, the MHX plate 100 further includes an encapsulation medium 103 that encapsulates the functional material 102, and a volume fraction of the encapsulation medium 103 in the MHX plate 100 is in a range from 0.01 to 0.2. In one embodiment, the supporting matrix 101 is filled with the functional material 102 and covered by the encapsulation medium 103, wherein the encapsulation medium 103 has a thickness less than 0.10 mm, an opening size less than 10 μm, and a gas permeance greater than 1×10⁻⁴ mol/(m²·s·Pa). In one embodiment, the encapsulation medium 103 may include a metal mesh that encapsulates the functional material 102 loaded in the supporting matrix 101, the metal mesh having a thickness less than 0.2 mm, an opening size less than 100 μm, and an open area fraction greater than 0.30. In one embodiment, the MHX plate 100 may include an encapsulation medium 103 configured to immobilize the functional material 102 in the supporting matrix 101, and the encapsulation medium 103 comprises a porous, thermally stable membrane that encapsulates the functional material 102 in the supporting matrix 101, has a thickness less than 0.1 mm, a pore size less than 10 μm, and gas permeance greater than 1×10⁻⁴ mol/(m²·s·Pa). In one embodiment, the MHX plate 100 may further include an encapsulation medium 103 configured to immobilize the functional material 102 in the supporting matrix 101, and the encapsulation medium 103 may include one of a porous metal/polymer hybrid or composite membrane that encapsulates the functional material 102 in the supporting matrix and is stable at 100° C. and has thickness less than 0.1 mm, a pore size less than 5 μm, and gas permeance greater than 1×10⁻⁴ mol/(m²·s·Pa).

According to another aspect of the present disclosure, a device for adsorption and desorption of a molecule in a process fluid is provided, which may include: a mass and heat transfer plate (MHX) plate 100 having a thermal conductivity greater than 20 W/(m·K) and a thickness in a range from 0.5 mm to 5.0 mm, and comprising: a supporting matrix 101 including a plurality of voids having a hydraulic diameter in a range from 0.5 mm to 6.0 mm; and an adsorbent material immobilized inside the plurality of voids at a volume fraction in a range from 0.2 to 0.80, wherein the MHX plate 100 includes a surface for diffusional mass transfer between the process fluid and the adsorbent material; a heat exchange tube 300 disposed on the MHX plate 100 configured to transfer heat between a thermal fluid in the heat exchange tube 300 and the MHX plate 100 by thermal conduction; and a process flow channel 200 configured to flow the process fluid to the MHX plate 100 and disposed proximate to the MHX plate 100 and a containment wall, wherein the process flow channel 200 has a hydraulic diameter in a range from 0.3 mm to 3.0 mm.

In one embodiment, the heat exchange tube 300 may include a plurality of heat exchange tubes 300 on the MHX plate 100 and a thermal conduction distance between the plurality of heat exchange tubes 300 is less than 20 cm. In one embodiment, the thermal fluid comprises cold thermal fluid introduced into the heat exchange tube 300 during adsorption to uniformly cool the MHX plate 100. In one embodiment, the thermal fluid comprises hot thermal fluid introduced into the heat exchange tube 300 during desorption to uniformly heat the MHX plate 100. In one embodiment, the adsorbent material is for selective CO₂ adsorption at a temperature less than 60° C. In one embodiment, the adsorbent material is for selective adsorption of alcohols at a temperature less than 60° C. In one embodiment, the adsorbent material is for selective adsorption of water molecules at a temperature less than 60° C. In one embodiment, the MHX plate 100 further includes an encapsulation medium 103 configured to fix the adsorbent material in the plurality of voids, wherein the encapsulation medium 103 has a thickness less than 0.10 mm, an opening size less than 10 μm, and a gas permeance greater than 1×10⁻⁴ mol/(m²·s·Pa). In one embodiment, the encapsulation medium 103 comprises one of a metal mesh, a porous metal membrane, a porous polymer membrane, metal/polymer hybrid membrane, or metal/polymer composite membrane.

According to another aspect of the present disclosure, a device for catalytic reaction of a molecule in a process fluid is provided, which may include: a mass and heat transfer (MHX) plate 100 having a thermal conductivity greater than 20 W/(m·K) and a thickness in a range from 0.5 mm to 5.0 mm, and including: a supporting matrix 101 including a plurality of voids having a hydraulic diameter in a range from 0.5 to 6.0 mm; and a catalytic material immobilized inside the plurality of voids at a volume fraction in a range from 0.2 to 0.80, the MHX plate 100 including a surface for diffusional mass transfer between the process fluid and the catalytic material; a heat exchange tube 300 disposed on the MHX plate and configured to transfer heat between a thermal fluid in the heat exchange tube 300 and the MHX plate 100 by thermal conduction; and a process channel 200 for flowing the process fluid to the MHX plate 100 and disposed proximate to the MHX plate 100 and a containment wall, the process channel having a hydraulic diameter in a range from 0.3 mm to 3.0 mm.

In one embodiment, the heat exchange tube 300 may include a plurality of heat exchange tubes 300 on the MHX plate 100 and a thermal conduction distance between the plurality of heat exchange tubes 300 is less than 20 cm. In one embodiment, the catalytic reaction comprises an exothermic catalytic reaction, and the thermal fluid comprises a cold thermal fluid introduced into the heat exchange tube 300 during the exothermic catalytic reaction to uniformly cool the MHX plate 100. In one embodiment, the catalytic reaction may include an endothermic catalytic reaction, and the thermal fluid may include a hot thermal fluid introduced into the heat exchange tube 300 during the endothermic catalytic reaction to uniformly heat the MHX plate 100. In one embodiment, the MHX plate 100 further includes an encapsulation medium 103 configured to fix the catalytic material in the plurality of voids, and the encapsulation medium 103 has a thickness less than 0.10 mm, an opening less than 10 μm, and a gas permeance greater than 1×10⁻⁴ mol/(m²·s·Pa). In one embodiment, the encapsulation medium 103 may include one of a metal mesh, a porous metal membrane, a ceramic membrane, a porous polymer membrane, metal/ceramic composite membrane, or metal/polymer composite membrane.

According to another aspect of the present disclosure, a device for thermal energy storage and heat exchange is provided, which may include: a mass and heat transfer (MHX) plate 100 having a thermal conductivity greater than 20 W/(m·K) and a thickness in a range from 0.5 mm to 5.0 mm, and including: a supporting matrix 101 including a plurality of voids having a hydraulic diameter in a range from 0.5 to 6.0 mm; and a thermal energy storage material immobilized inside the plurality of voids at a volume fraction in a range from 0.2 to 0.80, wherein the MHX plate 100 includes a surface for heat transfer between a process fluid and the thermal storage material; a heat exchange tube 300 disposed on the MHX plate 100 and configured to transfer heat between a thermal fluid and the MHX plate 100 by thermal conduction; and a process channel 200 for flowing the process fluid to the MHX plate 100 and disposed proximate to the MHX plate and a containment wall, the process channel having a hydraulic diameter in a range from 0.3 mm to 3.0 mm.

According to another aspect of the present disclosure, a method for capturing a molecule from a process fluid is provided, the method may include: providing an integrated mass and heat transfer (IMHX) device in a vessel 900, the IMHX device comprising: a mass and heat transfer (MHX) plate 100 including a supporting matrix 101 and an adsorbent material immobilized in the supporting matrix 101; a heat exchange tube 300 disposed on the MHX plate 100; and a channel 200 for flowing the process fluid to the MHX plate 100; passing the process fluid through the channel 200 at a pressure drop less than 1 kPa, so that the molecule in the process fluid is adsorbed on the adsorbent material; introducing a cold thermal fluid into the heat exchange tube 300 of the IMHX device for removal of heat of adsorption; stopping the passing of the process fluid when a concentration of the molecule in the process fluid exiting the IMHX device is below a threshold value; introducing a hot thermal fluid into the heat exchange tube 300 of the IMHX device to heat the adsorbent to a temperature for desorption of the adsorbed molecule from the adsorbent material; and introducing cold thermal fluid into the heat exchange tube 300 of the IMHX device to cool the adsorbent material to a temperature close to a process temperature. In one embodiment, the MHX plate 100 may have a thermal conductivity greater than 20 W/(m·K) and a thickness in a range from 0.5 mm to 5.0 mm, the supporting matrix includes a plurality of voids having a hydraulic diameter in a range from 0.5 mm to 6.0 mm, the adsorbent material is immobilized inside the plurality of voids at a volume fraction of 0.2 to 0.80, and the MHX plate 100 includes a surface for diffusional mass transfer between the process fluid and the adsorbent material, wherein the heat exchange tube 300 comprises a plurality of heat exchange tubes 300 configured to transfer heat between a thermal fluid and the MHX plate 100 by thermal conduction and a thermal conduction distance between the plurality of heat exchange tubes 300 is less than 20 cm, and wherein the channel 200 flows the process fluid between the MHX plate 100 and a containment wall and has a hydraulic diameter in a range from 0.5 mm to 3.0 mm.

In one embodiment, the MHX plate 100 further includes an encapsulation medium 103 configured to fix the adsorbent material in the supporting matrix 101, and the encapsulation medium 103 has a thickness less than 0.10 mm, an opening size less than 10 μm, and a gas permeance greater than 1×10⁻⁴ mol/(m²·s·Pa). In one embodiment, the encapsulation medium 103 includes one of a metal mesh, a porous metal membrane, a ceramic membrane, metal/ceramic composite membrane, polymer membrane, or metal/polymer composite membrane. In one embodiment, the method may also include passing a sweep fluid through the channel 200 during the desorption of the adsorbed molecule from the adsorbent material. In one embodiment, the method may also include applying a vacuum on the vessel 900 during the desorption of the adsorbed molecule from the adsorbent material.

According to another aspect of the present disclosure, a method for capturing CO₂ from air is provided, the method may include: providing an integrated mass and heat transfer (IMHX) device in a vessel 900, the IMHX device including: a mass and heat transfer (MHX) plate 100 comprising a supporting matrix 101 and an adsorbent material immobilized in the supporting matrix; a heat exchange tube 300 disposed on the MHX plate 100; and a channel 200 configured to flow air to the MHX plate; passing the air through the channel 200 at pressure drop less than 1 kPa so that CO₂ in the air is adsorbed on the adsorbent material; stopping a flow of the air when a CO₂ concentration of the air exiting the IMHX device is below a threshold value; switching a mode of the IMHX device to a regeneration mode; introducing a hot thermal fluid into the heat exchange tube 300 of the IMHX device to heat the adsorbent to a temperature for desorption of the adsorbed CO₂ from the adsorbent material; and introducing cold thermal fluid into the heat exchange tube 300 of the IMHX device to cool the adsorbent material to an ambient air temperature.

In one embodiment, the MHX plate 100 has a thermal conductivity greater than 20 W/(m·K) and a thickness in a range from 0.5 mm to 5.0 mm, the supporting matrix 101 includes a plurality of voids having a hydraulic diameter in a range from 0.5 to 6.0 mm, the adsorbent material is immobilized inside the plurality of voids at a volume fraction of 0.2 to 0.80, and the MHX plate includes a surface for diffusional mass transfer between the air and the adsorbent material, wherein the heat exchange tube 300 comprises a plurality of heat exchange tubes 300 configured to transfer heat between a thermal fluid and the MHX plate 100 by thermal conduction and a thermal conduction distance between the plurality of heat exchange tubes 300 is less than 20 cm, and wherein the channel flows the process fluid between the MHX plate and a containment wall and has a hydraulic diameter in a range from 0.5 mm to 3.0 mm. In one embodiment, the MHX plate 100 further includes an encapsulation medium 103 configured to fix the adsorbent material in the supporting matrix, and the encapsulation medium 103 has a thickness less than 0.10 mm, an opening size less than 10 μm, and a gas permeance greater than 1×10⁻⁴ mol/(m²·s·Pa). In one embodiment, the encapsulation medium 103 may include one of a metal mesh, a porous metal membrane, porous ceramic membrane, a porous polymer membrane, metal/ceramic composite membrane, metal/polymer composite membrane, or ceramic/polymer composite membrane. In one embodiment, the switching of the IMHX device to a regeneration mode comprises moving the IMHX device into a regeneration chamber. In one embodiment, the method may further include the step of applying a vacuum on the regeneration chamber during the desorption of the adsorbed CO₂ from the adsorbent material. In one embodiment, the method may further include the step of passing a sweep gas through the channel during the desorption of the adsorbed CO₂ from the adsorbent material. In one embodiment, the introducing of the hot thermal fluid comprises incrementally increasing a temperature of the hot thermal fluid. In one embodiment, the introducing of the cold thermal fluid comprises incrementally decreasing a temperature of the cold thermal fluid. In one embodiment, the introducing of the cold thermal fluid comprises storing a sensible heat of a thermal fluid exiting the IMHX device in a thermal energy storage vessel. In one embodiment, the hot thermal fluid is produced using a heat pump.

The method steps (process steps) of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skills in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A device for mass and heat transfer, comprising:
a mass and heat transfer (MHX) plate having a thickness in a range from 0.5 mm to 5 mm and comprising:
a supporting matrix that is thermally conductive; and
a functional material in the supporting matrix, wherein a volume fraction of the functional material in the MHX plate is in a range from 0.2 to 0.8; and
a heat exchange tube configured to transport a thermal fluid and disposed on the MHX plate such that heat is transferred between the thermal fluid and the MHX plate, wherein a surface of the MHX plate comprises a process flow channel of hydraulic diameter in a range from 0.3 mm to 3 mm and a process fluid in the process flow channel exchanges heat with the MHX plate.

2. The device of claim 1, wherein the MHX plate comprises a plurality of MHX plates stacked in parallel, the heat exchange tube comprises a plurality of heat exchange tubes at a spacing in a range from 5 mm to 200 mm and the process flow channel is located between the plurality of heat exchange tubes and the plurality of MHX plates.

3. The device of claim 2, further comprising:
a thermal conducting spacer between the plurality of MHX plates to enforce mechanical integrity of the plurality of MHX plates and enhance heat transfer between the plurality of heat exchange tubes and the plurality of MHX plates.

4. The device of claim 1, wherein the supporting matrix comprises one of aluminum or copper and has a thermal conductivity greater than 50 W/(m·K).

5. The device of claim 1, wherein the heat exchange tube has a hydraulic diameter in a range from 1 mm to 30 mm and has a thermal flow direction perpendicular to a surface of the MHX plate.

6. The device of claim 1, wherein the heat exchange tube has a hydraulic diameter in a range from 1 mm to 5 mm and has a thermal flow direction parallel to a surface of the MHX plate.

7. The device of claim 1, wherein the functional material comprises one of a powder or particle having a particle size less than 0.1 mm.

8. The device of claim 1, wherein the supporting matrix comprises a plurality of voids having a hydraulic diameter in a range from 0.5 mm to 6.0 mm and the functional material is in the plurality of voids.

9. The device of claim 1, wherein the process fluid in the process flow channel exchanges mass with the MHX plate and the functional material comprises a solid sorbent for selective adsorption of a molecule in the process fluid.

10. The device of claim 1, wherein the functional material comprises a catalyst to catalyze a reaction of a molecule in the process fluid.

11. The device of claim 1, wherein the MHX plate further comprises an encapsulation medium that encapsulates the functional material, and a volume fraction of the encapsulation medium in the MHX plate is in a range from 0.01 to 0.2.

12. The device of claim 11, wherein the supporting matrix is filled with the functional material and covered by the encapsulation medium, wherein the encapsulation medium has a thickness less than 0.10 mm, an opening size less than 10 μm, and a gas permeance greater than 1×10⁻⁴ mol/(m²·s·Pa).

13. The device of claim 11, wherein the encapsulation medium comprises a metal mesh that encapsulates the functional material loaded in the supporting matrix, the metal mesh having a thickness less than 0.2 mm, an opening size less than 100 μm, and an open area fraction greater than 0.30.

14. The device of claim 1, wherein the MHX plate further comprises an encapsulation medium configured to immobilize the functional material in the supporting matrix, and the encapsulation medium comprises a porous, thermally stable membrane that encapsulates the functional material in the supporting matrix, has a thickness less than 0.1 mm, a pore size less than 5 μm, and gas permeance greater than 1×10⁻⁴ mol/(m²·s·Pa).

15. The device of claim 1, wherein the MHX plate further comprises an encapsulation medium configured to immobilize the functional material in the supporting matrix, and the encapsulation medium comprises one of a porous metal/polymer hybrid or composite membrane that encapsulates the functional material in the supporting matrix and is stable at 100° C. and has thickness less than 0.1 mm, a pore size less than 5 μm, and gas permeance greater than 1×10⁻⁴ mol/(m²·s·Pa).

16. A device for adsorption and desorption of a molecule in a process fluid, the device comprising:
a mass and heat transfer plate (MHX) plate having a thermal conductivity greater than 20 W/(m·K) and a thickness in a range from 0.5 mm to 5.0 mm, and comprising:
a supporting matrix including a plurality of voids having a hydraulic diameter in a range from 0.5 mm to 6.0 mm; and
an adsorbent material immobilized inside the plurality of voids at a volume fraction in a range from 0.2 to 0.80, wherein the MHX plate includes a surface for diffusional mass transfer between the process fluid and the adsorbent material;
a heat exchange tube disposed on the MHX plate configured to transfer heat between a thermal fluid in the heat exchange tube and the MHX plate by thermal conduction; and
a process flow channel configured to flow the process fluid to the MHX plate and disposed proximate to the MHX plate and a containment wall, wherein the process flow channel has a hydraulic diameter in a range from 0.3 mm to 3.0 mm.

17. The device of claim 16, wherein the heat exchange tube comprises a plurality of heat exchange tubes on the MHX plate and a thermal conduction distance between the plurality of heat exchange tubes is less than 20 cm.

18. The device of claim 16, wherein the thermal fluid comprises cold thermal fluid introduced into the heat exchange tube during adsorption to uniformly cool the MHX plate.

19. The device of claim 16, wherein the thermal fluid comprises hot thermal fluid introduced into the heat exchange tube during desorption to uniformly heat the MHX plate.

20. The device of claim 16, wherein the adsorbent material is for selective CO₂ adsorption at a temperature less than 60° C.

21. The device of claim 16, wherein the adsorbent material is for selective adsorption of alcohols at a temperature less than 60° C.

22. The device of claim 16, wherein the adsorbent material is for selective adsorption of water molecules at a temperature less than 60° C.

23. The device of claim 16, wherein the MHX plate further comprises an encapsulation medium configured to fix the adsorbent material in the plurality of voids, wherein the encapsulation medium has a thickness less than 0.10 mm, an opening size less than 10 μm, and a gas permeance greater than 1×10⁻⁴ mol/(m²·s·Pa).

24. The device of claim 23, wherein the encapsulation medium comprises one of a metal mesh, a porous metal membrane, a porous polymer membrane, metal/polymer hybrid membrane, or metal/polymer composite membrane.

25. A device for catalytic reaction of a molecule in a process fluid, the device comprising:
a mass and heat transfer (MHX) plate having a thermal conductivity greater than 20 W/(m·K) and a thickness in a range from 0.5 mm to 5.0 mm, and comprising:
a supporting matrix including a plurality of voids having a hydraulic diameter in a range from 0.5 to 6.0 mm; and
a catalytic material immobilized inside the plurality of voids at a volume fraction in a range from 0.2 to 0.80, the MHX plate including a surface for diffusional mass transfer between the process fluid and the catalytic material;
a heat exchange tube disposed on the MHX plate and configured to transfer heat between a thermal fluid in the heat exchange tube and the MHX plate by thermal conduction; and
a process channel for flowing the process fluid to the MHX plate and disposed proximate to the MHX plate and a containment wall, the process channel having a hydraulic diameter in a range from 0.3 mm to 3.0 mm.

26. The device of claim 25, wherein the heat exchange tube comprises a plurality of heat exchange tubes on the MHX plate and a thermal conduction distance between the plurality of heat exchange tubes is less than 20 cm.

27. The device of claim 25, wherein the catalytic reaction comprises an exothermic catalytic reaction, and the thermal fluid comprises a cold thermal fluid introduced into the heat exchange tube during the exothermic catalytic reaction to uniformly cool the MHX plate.

28. The device of claim 25, wherein the catalytic reaction comprises an endothermic catalytic reaction, and the thermal fluid comprises a hot thermal fluid introduced into the heat exchange tube during the endothermic catalytic reaction to uniformly heat the MHX plate.

29. The device of claim 25, wherein the MHX plate further comprises an encapsulation medium configured to fix the catalytic material in the plurality of voids, and the encapsulation medium has a thickness less than 0.10 mm, an opening less than 10 μm, and a gas permeance greater than 1×10⁻⁴ mol/(m²·s·Pa).

30. The device of claim 29, wherein the encapsulation medium comprises one of a metal mesh, a porous metal membrane, a ceramic membrane, a porous polymer membrane, metal/ceramic composite membrane, or metal/polymer composite membrane.

31. A device for thermal energy storage and heat exchange, the device comprising:
a mass and heat transfer (MHX) plate having a thermal conductivity greater than 20 W/(m·K) and a thickness in a range from 0.5 mm to 5.0 mm, and comprising:
a supporting matrix including a plurality of voids having a hydraulic diameter in a range from 0.5 to 6.0 mm; and
a thermal energy storage material immobilized inside the plurality of voids at a volume fraction in a range from 0.2 to 0.80, wherein the MHX plate includes a surface for heat transfer between a process fluid and the thermal storage material;
a heat exchange tube disposed on the MHX plate and configured to transfer heat between a thermal fluid and the MHX plate by thermal conduction; and
a process channel for flowing the process fluid to the MHX plate and disposed proximate to the MHX plate and a containment wall, the process channel having a hydraulic diameter in a range from 0.3 mm to 3.0 mm.

32. A method for capturing a molecule from a process fluid, the method comprising:
providing an integrated mass and heat transfer (IMHX) device in a vessel, the IMHX device comprising:
a mass and heat transfer (MHX) plate comprising a supporting matrix and an adsorbent material immobilized in the supporting matrix;
a heat exchange tube disposed on the MHX plate; and
a channel for flowing the process fluid to the MHX plate;
passing the process fluid through the channel at a pressure drop less than 1 kPa, so that the molecule in the process fluid is adsorbed on the adsorbent material;
introducing a cold thermal fluid into the heat exchange tube of the IMHX device for removal of heat of adsorption;
stopping the passing of the process fluid when a concentration of the molecule in the process fluid exiting the IMHX device is below a threshold value;
introducing a hot thermal fluid into the heat exchange tube of the IMHX device to heat the adsorbent to a temperature for desorption of the adsorbed molecule from the adsorbent material; and
introducing cold thermal fluid into the heat exchange tube of the IMHX device to cool the adsorbent material to a temperature close to a process temperature.

33. The method of claim 32, wherein the MHX plate has a thermal conductivity greater than 20 W/(m·K) and a thickness in a range from 0.5 mm to 5.0 mm, the supporting matrix includes a plurality of voids having a hydraulic diameter in a range from 0.5 mm to 6.0 mm, the adsorbent material is immobilized inside the plurality of voids at a volume fraction of 0.2 to 0.80, and the MHX plate includes a surface for diffusional mass transfer between the process fluid and the adsorbent material,
wherein the heat exchange tube comprises a plurality of heat exchange tubes configured to transfer heat between a thermal fluid and the MHX plate by thermal conduction and a thermal conduction distance between the plurality of heat exchange tubes is less than 20 cm, and
wherein the channel flows the process fluid between the MHX plate and a containment wall and has a hydraulic diameter in a range from 0.5 mm to 3.0 mm.

34. The method of claim 32, wherein the MHX plate further comprises an encapsulation medium configured to fix the adsorbent material in the supporting matrix, and the encapsulation medium has a thickness less than 0.10 mm, an opening size less than 10 μm, and a gas permeance greater than 1×10⁻⁴ mol/(m²·s·Pa).

35. The method of claim 34, wherein the encapsulation medium comprises one of a metal mesh, a porous metal membrane, a ceramic membrane, metal/ceramic composite membrane, polymer membrane, or metal/polymer composite membrane.

36. The method of claim 32, further comprising:
applying a vacuum on the vessel during the desorption of the adsorbed molecule from the adsorbent material.

37. The method of claim 32, further comprising:
passing a sweep fluid through the channel during the desorption of the adsorbed molecule from the adsorbent material.

38. A method for capturing CO₂ from air, the method comprising:
providing an integrated mass and heat transfer (IMHX) device in a vessel, the IMHX device comprising:
a mass and heat transfer (MHX) plate comprising a supporting matrix and an adsorbent material immobilized in the supporting matrix;
a heat exchange tube disposed on the MHX plate; and
a channel configured to flow air to the MHX plate;
passing the air through the channel at pressure drop less than 1 kPa so that CO₂ in the air is adsorbed on the adsorbent material;
stopping a flow of the air when a CO₂ concentration of the air exiting the IMHX device is below a threshold value;
switching a mode of the IMHX device to a regeneration mode;
introducing a hot thermal fluid into the heat exchange tube of the IMHX device to heat the adsorbent to a temperature for desorption of the adsorbed CO₂ from the adsorbent material; and
introducing cold thermal fluid into the heat exchange tube of the IMHX device to cool the adsorbent material to an ambient air temperature.

39. The method of claim 38, wherein the MHX plate has a thermal conductivity greater than 20 W/(m·K) and a thickness in a range from 0.5 mm to 5.0 mm, the supporting matrix includes a plurality of voids having a hydraulic diameter in a range from 0.5 to 6.0 mm, the adsorbent material is immobilized inside the plurality of voids at a volume fraction of 0.2 to 0.80, and the MHX plate includes a surface for diffusional mass transfer between the air and the adsorbent material,
wherein the heat exchange tube comprises a plurality of heat exchange tubes configured to transfer heat between a thermal fluid and the MHX plate by thermal conduction and a thermal conduction distance between the plurality of heat exchange tubes is less than 20 cm, and
wherein the channel flows the process fluid between the MHX plate and a containment wall and has a hydraulic diameter in a range from 0.5 mm to 3.0 mm.

40. The method of claim 38, wherein the MHX plate further comprises an encapsulation medium configured to fix the adsorbent material in the supporting matrix, and the encapsulation medium has a thickness less than 0.10 mm, an opening size less than 10 μm, and a gas permeance greater than 1×10⁻⁴ mol/(m²·s·Pa).

41. The method of claim 40, wherein the encapsulation medium comprises one of a metal mesh, a porous metal membrane, porous ceramic membrane, a porous polymer membrane, metal/ceramic composite membrane, metal/polymer composite membrane, or ceramic/polymer composite membrane.

42. The method of claim 38, wherein the switching of the IMHX device to a regeneration mode comprises moving the IMHX device into a regeneration chamber.

43. The method of claim 42, further comprising:
applying a vacuum on the regeneration chamber during the desorption of the adsorbed CO₂ from the adsorbent material.

44. The method of claim 38, further comprising:
passing a sweep gas through the channel during the desorption of the adsorbed CO₂ from the adsorbent material.

45. The method of claim 38, wherein the introducing of the hot thermal fluid comprises incrementally increasing a temperature of the hot thermal fluid.

46. The method of claim 38, wherein the introducing of the cold thermal fluid comprises incrementally decreasing a temperature of the cold thermal fluid.

47. The method of claim 38, wherein the introducing of the cold thermal fluid comprises storing a sensible heat of a thermal fluid exiting the IMHX device in a thermal energy storage vessel.

48. The method of claim 38, wherein the hot thermal fluid is produced using a heat pump.
